(19) United States
(12) Patent Application Publication
(10) Pub. No.: US 2004/0115553 A1
(43) Pub. Date: Jun. 17, 2004

(54) Toner and image forming method

(75) Inventors: Takao Yamanouchi, Tokyo (JP); Masafumi Uchida, Tokyo (JP); Masahiro Anno, Osaka (JP); Yoshitaka Sekiguchi, Nishinomiya-shi (JP); Minoru Nakamura, Takarazuka-shi (JP)

Correspondence Address: Muserlian, Lucas and Mercanti, 600 Third Avenue, New York, NY, 10016, US

(73) Assignees: Konica Minolta Holdings, Inc., Tokyo (JP); Minolta Co., Ltd., Osaka (JP)

(21) Appl. No.: 10/665,592

(22) Filed: Sep. 18, 2003

(30) Foreign Application Priority Data
Sep. 19, 2002 (JP) 2002-273209

(51) Int. Cl. G03G 9/00; G03G 13/20; G03G 15/02; G03G 15/08

(52) U.S. Cl. 430/111.4; 399/262; 430/109.4; 399/176; 430/124; 430/109.3

(57) ABSTRACT

A toner includes a resin and a colorant; wherein the toner is obtained by carrying out a step of salting-out/fusing resin particles and colorant particles in a water-base medium, the toner satisfying the following relationship: 0.88≦F25/F50≦1.0, where F25 represents an adhesive stress at a toner temperature of 25° C., and F50 represents an adhesive stress at a toner temperature of 50° C.

### BACKGROUND OF THE INVENTION

1. Field of the Invention

The present invention relates to a toner, and an image forming method.

2. Description of the Related Art

Conventionally, to form a color image e.g. by electronic photography, for example, a non-magnetic single component development system in which a latent image formed on an electrostatic latent image carrier is developed by a toner carried and transferred by a toner carrier to which a toner layer limiting member for limiting the amount of the toner on the surface of the toner carrier is pressed, is employed.

In the non-magnetic single component development system, when the toner layer limiting member limits the amount of toner on the toner carrier, the toner is frictionally charged. Thereby, the toner is transferred by the toner carrier. Therefore, to give a necessary amount of electric charge to the toner by the frictional charge, a large shearing stress is inevitably applied to the toner and can crush the toner particles. A problem that the fine toner particles caused by the crush are attached to components of an image forming apparatus, such as the toner carrier, to degrade the image formability of the toner, is caused. To solve the problem, there have been proposed various solutions (see, for example, Patent Documents 1 to 4).

Recently, in the non-magnetic single component development system, a polymerization toner having uniform electrostatic chargeability and exhibiting a sharp electrostatic charge distribution due to its uniformity in shape and particle diameter has been suitably employed as a non-magnetic single component developer.

One known technique of obtaining a polymerization toner is a suspension polymerization method. However, particles of the toner obtained by the suspension polymerization method are spherical in shape and has a high adhesiveness to an image support and the like. Therefore, if the toner obtained by the suspension polymerization method is used as the non-magnetic single component developer, there is a fear of generation of a development ghost. To overcome this problem, as the non-magnetic single component developer, a toner produced by a so-called association method is widely used (see, for example, Patent Document 5 to 8) which includes a step of salting-out/fusing resin particles and colorant particles in a water-base medium, since the shape of toner particles to be formed can be controlled to various shapes ranging from a spherical shape to an indefinite shape, and moreover the characteristics thereof can be controlled by sharpening the particle diameter distribution.

However, even when the toner obtained by the association method is used as the non-magnetic single component developer, there can occur an image defect, such as hollowing of an image obtained, and fogging. After all, it is impossible to obtain a high-quality image, with stability.

Patent Document 1:

Japanese Laid-Open Patent Publication No. 8-240927

Patent Document 2:

Japanese Laid-Open Patent Publication No. 8-248669

Patent Document 3:

Japanese Laid-Open Patent Publication No. 10-161335

Patent Document 4:

Japanese Laid-Open Patent Publication No. 10-265721

Patent Document 5:

Japanese Laid-Open Patent Publication No. 2000-214629

Patent Document 6:

Japanese Laid-Open Patent Publication No. 5-265252

Patent Document 7:

Japanese Laid-Open Patent Publication No. 6-329947

Patent Document 8:

Japanese Laid-Open Patent Publication No. 9-15904

Patent Document 9:

Japanese Laid-Open Patent Publication No. 2000-169326

The present inventors have carried out extensive investigation and study on the problem brought about when the associated-type toner is used as the non-magnetic single component developer, and presumed that such a problem is caused by application of shearing stress to the toner by the action of frictional charge caused by the toner carrier and the toner layer limiting member, which generates a frictional heat on surfaces of toner particles, some of which are melted by the frictional heat, and attached, as stains, to the components of the image forming apparatus.

### SUMMARY OF THE INVENTION

The present invention has been made in view of the above circumstances, and an object thereof is to provide a toner with which a high-quality image can be stably obtained by the non-magnetic single component development system.

Another object of the present invention is to provide an image forming method which makes it possible to stably obtain a high-quality image by the non-magnetic single component development system.

In accordance with the first aspect of the present invention, a toner comprises a resin and a colorant; wherein the toner is obtained by carrying out a step of salting-out/fusing resin particles and colorant particles in a water-base medium, the toner satisfying the following relationship:

0.88≦F25/F50≦1.0

where F25 represents an adhesive stress at a toner temperature of 25° C., and F50 represents an adhesive stress at a toner temperature of 50° C.

Preferably, the toner has a volume average particle diameter of 9 μm or less.

Preferably, the toner has a peak or a shoulder in a molecular weight distribution range from 100,000 to 1,000,000, and from 1,000 to 50,000.

Preferably, the toner contains external additives having different number average primary particle diameters.

Preferably, one of the external additives is a small-sized external additive having a number average primary particle diameter of 30 nm or less.

Preferably, one of the external additives is a large-sized external additive having a number average primary particle diameter larger than that of the small-sized external additive, and of 15 to 70 nm.

In accordance with the second aspect of the invention, an image forming method comprises the steps of:

limiting an amount of toner on a surface of a toner carrier by allowing a toner layer limiting member to be pressed to the surface of the toner carrier; and

developing an electrostatic latent image formed on an electrostatic latent image carrier using the toner carried and transferred by the toner carrier, based on a non-magnetic single component development system,

wherein the toner comprises a resin and a colorant, and is obtained by carrying out a step of salting-out/fusing resin particles and colorant particles in a water-base medium, the toner satisfying the following relationship:

0.88≦F25/F50≦1.0

where F25 represents an adhesive stress at a toner temperature of 25° C., and F50 represents an adhesive stress at a toner temperature of 50° C.

Preferably, the toner has a volume average particle diameter of 9 μm or less.

Preferably, the toner has a peak or a shoulder respectively in a molecular weight distribution range from 100,000 to 1,000,000, and from 1,000 to 50,000.

Preferably, the toner contains external additives having different number average primary particle diameters.

Preferably, one of the external additives is a small-sized external additive having a number average primary particle diameter of 30 nm or less.

Preferably, one of the external additives is a large-sized external additive having a number average primary particle diameter larger than that of the small-sized external additive, and of 15 to 70 nm.

In accordance with the third aspect of the invention, an image forming method comprises the steps of:

limiting an amount of toner on a surface of a toner carrier by allowing a toner layer limiting member to be pressed to the surface of the toner carrier; and

developing an electrostatic latent image formed on an electrostatic latent image carrier using the toner carried and transferred by the toner carrier, based on a non-magnetic single component development system,

wherein the toner comprises a resin and a colorant, and is obtained by carrying out a step of salting-out/fusing resin particles and colorant particles in a water-base medium, the toner satisfying the following relationship:

0.88≦F25/F50≦1.0

where F25 represents an adhesive stress at a toner temperature of 25° C., and F50 represents an adhesive stress at a toner temperature of 50° C., and

wherein the toner carrier has an arithmetic mean roughness Ra of 0.8 to 2.5 μm and a ten-point average roughness Rz of 5.0 to 15.0.

Preferably, the toner has a peak or shoulder respectively in a molecular weight distribution range from 100,000 to 1,000,000, and from 1,000 to 50,000.

Preferably, the toner contains external additives having different number average primary particle diameters.

Preferably, one of the external additives is a small-sized external additive having a number average primary particle diameter of 30 nm or less.

Preferably, one of the external additives is a large-sized external additive having a number average primary particle diameter larger than that of the small-sized external additive, and of 15 to 70 nm.

The toner according to the present invention is a so-called associated-type toner obtained by carrying out the step of salting-out/fusing resin particles and colorant particles in a water-base medium. The toner has a ratio related to specific magnitudes of adhesive stress, and therefore temperature dependency of the adhesiveness between toner particles is small, and therefore it is possible to obtain an excellent image formability. This makes it possible to give a necessary amount of electric charge to the toner without detrimental effects of the action of frictional charge by the toner carrier and the toner layer limiting member. This makes it possible to obtain a high-quality image over a long time period.

Therefore, according to the toner of the present invention, it is possible to stably obtain a high-quality image by the non-magnetic single component development system.

### BRIEF DESCRIPTION OF THE DRAWINGS

FIG. 1A is an explanatory view showing a projection image of a rounded toner particle;

FIGS. 1B and 1C are respective explanatory views showing projection images of angular toner particles;

FIG. 2 is an explanatory schematic view showing an example of the arrangement of an image forming apparatus used in the present invention;

FIG. 3 is an explanatory cross-sectional view of the arrangement of a developing unit of a developing device of the image forming apparatus shown in FIG. 2;

FIG. 4 is an explanatory view illustrating a curve indicative of a contour of cross-section of a portion of a toner carrier; and

FIG. 5 is an explanatory view useful in explaining a ten-point average roughness Rz.

### DETAILED DESCRIPTION OF THE PREFERRED EMBODIMENTS

The invention will now be described in detail with reference to the drawings showing a preferred embodiment thereof.

Toner according to the present invention contains a resin, and a colorant. The toner is obtained by carrying out the step of salting out/fusing resin particles and colorant particles, and has a characteristic that an adhesive stress F25 of the toner at a temperature of 25° C. and an adhesive stress F50 of the toner at a temperature of 50° C. satisfy the relationship of 0.88≦F25/F50≦1.0.

Further, the toner may contain an additive, such as an external additive.

The term “adhesive stress” is intended to mean a value indicating adhesiveness between toner particles, which is obtained by an apparatus for measuring the compressive and tensile characteristics of a powder layer (such as “Aggrobot” available from Hosokawa Micron Corporation). More specifically, according to measurement conditions for a spring wire having a diameter of 1.0 mm, in a measurement environment of 23° C. and 50% RH, toner is filled in an amount of a volume of 10 cm³ in the compressed state in a hollow cylindrical cell that is dividable into an upper cell and a lower cell and has an inner diameter of 25 mm, and then, a toner layer formed by the toner filled in the cell is maintained under compression conditions of a compression speed 0.1 mm/sec and a compression stress of 2×10⁵ N/m², for a predetermined time period dependent on the temperature condition for setting the toner temperature to 25° C. or 50° C. (for 60 seconds in the case of the temperature condition setting the toner temperature to 25° C., or for 660 seconds in the case of the temperature condition setting the toner temperature to 50° C.). Then, the upper cell is lifted at a pulling speed of 0.4 mm/sec, and a maximum tensile stress (N/m²) acting when the toner is broken is measured as the adhesive stress F25 (for the toner temperature 25° C.) and the adhesive stress F50 (for the toner temperature 50° C.).

When the ratio of the adhesive stress F25 to the adhesive stress F50 (hereinafter referred to as the “adhesive stress ratio”) is equal to or larger than 0.88 and smaller than 1.0, it is possible to suppress occurrence of a toner-fusing phenomenon, and stably obtain a high-quality image.

The reason for this is presumed as follows: The rate of change in adhesive stress, which is increased as the toner temperature rises, is small, and therefore the adhesiveness between the toner particles is not significantly increased even if the toner temperature is raised by a frictional heat generated on surfaces of toner particles through application of shearing stress, and further since the adhesiveness between the toner particles is not significantly increased, generation of the frictional heat on the surfaces of the toner particles is suppressed.

In the present invention, the adhesive stress is preferably 100 to 1200 N/m², more preferably 200 to 1000 N/m². When the adhesive stress exceeds 1200 N/m², there is a fear that transferability is degraded, thereby causing hollowing of an image obtained. Further, when a full color image is to be formed, or when releasing agent is contained in toner particles, occurrence of hollowing of an image becomes marked. Particularly, when a full color toner for oilless fixation, containing a large amount of a releasing agent, is used, a cohesive force between the toner particles is increased to form a toner layer comprised of two or more layers, on an intermediate transfer body, whereby hollowing is liable to occur in an image when the image is transferred to a medium, such as an image support. These characteristics can be improved by controlling the adhesive stress within the range of values described above.

It should be noted that throughout the specification, the term “transferability” is intended to mean easiness of transferring a toner image, and in the case where the toner image is formed on a surface of an electrostatic latent image carrier by development and transferred to a material to which the image is to be transferred, the transferability means easiness of transfer of the toner image from the electrostatic latent image carrier to the intermediate transfer body as well from the intermediate transfer body to the material to which the image is to be transferred.

The adhesive stress is controlled by the circularity and fine powder content of the toner, the surface characteristics of the toner particles, and the kind and amount of an external additive added to the toner. For example, to reduce the adhesive stress, the average circularity of the toner is increased. Further, it is effective to reduce variations in the circularity to thereby reduce a standard deviation value (SD value) of the circularity. Also, it is preferable to decrease the fine powder content to sharpen a particle diameter distribution of the toner. Furthermore, it is preferable to reduce relatively large irregularities on the surfaces of the toner particles, and at the same time provide minute irregularities thereon. It is also preferable that an externally-added processing agent having a suitable particle diameter is used, and at the same time the amount of the external additive added to the toner is increased. However, if the external additive is added to the toner in an excessively large amount, increased scattering of toner may degrade the image quality and contamination of the electrostatic latent image carrier may be caused by transfer of the external additive.

Preferably, the adhesive stress F25 is in a range of 300 to 800 N/m², more preferably 400 to 600 N/m².

Also preferably, the adhesive stress F50 is in a range of 400 to 900 N/m², more preferably 450 to 700 N/m².

The adhesive stress ratio of a toner can be easily controlled to a value within a predetermined range, by forming the toner such that the toner is formed by particles which are spherical and uniform in shape, that the toner has a sharp particle diameter distribution, and that the toner has a small fine powder content, and that a predetermined external additive is added to the toner, more specifically, by forming the toner having any one of the following features (a) to (c).

Now, the toner according to the present invention is only required to have at least one of the features (a) to (c). Further, the toner according to the present invention may have a plurality of the features (a) to (c) (hereinafter referred to as the “predetermined features”).

(a) A shape factor is 1.0 to 1.5, and a coefficient of variation of shape factor is 16% or less.

(b) A ratio of toner particles having a volume average particle diameter of 2.5 μm, to all the toner particles, is 10 volume % or less.

(c) An external additive comprised of particles having a small diameter (hereinafter referred to as “the small-sized external additive”) is added.

It is preferred that the toner according to the present invention has a shape factor of 1.0 to 1.5, and a coefficient of variation of shape factor is 16% or less. More preferably, the toner according to the present invention satisfies these conditions, and at the same time a ratio of rounded toner particles to all the toner particles is 50 number % or more.

Although the reason for this is not clear, it is presumed that the shearing stress applied to the toner is generated not only by the action of frictional charge caused by a toner carrier and a toner layer limiting member but also by friction between the toner particles, and the shearing stress generated by the friction between the toner particles is increased with an increase in the difference in shape between the toner particles. Therefore, it is presumed that the adhesive stress ratio of the toner can be controlled to a value within the predetermined range by reducing the difference in shape between the toner particles.

In the toner according to the present invention, the “shape factor” is represented by the following Equation (1), and indicates a degree of roundness of toner particles.

Shape factor=((maximum diameter/2)²×π/projected area (1)

wherein the maximum diameter indicates the width of a toner particle which maximizes a distance between two parallel lines sandwiching a projection image of the toner particle, projected onto a plane. Further, the projected area means an area of the toner image projected onto the plane.

In the present invention, the shape factor is measured as follows: First, a photograph of a toner particle magnified up to 2000 times is taken by a scanning electron microscope, and then a photographic image is analyzed based on the photograph using “Scanning Image Analyzer” (available from Nippon Denshi Co., Ltd.), for measurement. One hundred toner particles were measured to calculate values of shape factors by the above equation, and the shape factor defined herein indicates an arithmetic average value of those calculated shape factor values.

In the toner according to the present invention, the “coefficient of variation of shape factor” is calculated by the following Equation (2):

Coefficient of variation of shape factor=(S₁/K)×100(%) (2)

wherein, S1 represents a standard deviation of the shape factor of the 100 toner particles, and K represents an average value of the shape factors.

To uniformly control the coefficient of variation of shape factor and the shape factor itself of the toner without lot-to-lot variations, an appropriate time point for terminating the salting-out/fusing step and aging treatment may be determined while monitoring the characteristics of toner particles (colorant particles) being formed.

Now, the term “monitoring” is intended to mean executing control of conditions under which a processing step is to be carried out, based on results of measurement of shapes and the like, integrated as an in-line process. More specifically, in the case of a polymerized toner, for example, which is formed by associating or fusing resin particles with each other in a water-base medium, shapes and sizes of the particles are measured while sequentially performing sampling in a fusing step or the like, and when desired shapes are obtained, the reaction is stopped.

Although the monitoring method is not particularly limited, it is possible to employ a flow-type particle image analyzer “FPIA-2000” (available from Toa Medical Electronics Co., Ltd.). This analyzer is suitable for the above monitoring, since it is capable of performing image processing of toner particles while causing sample liquid to flow therethrough, thereby enabling shapes of the tone particles to be monitored in real time. More specifically, the analyzer always monitors and measures shapes of toner particles while causing sample liquid from a reaction vessel to flow therethrough e.g. by using a pump, and the reaction is stopped when desired shapes are obtained.

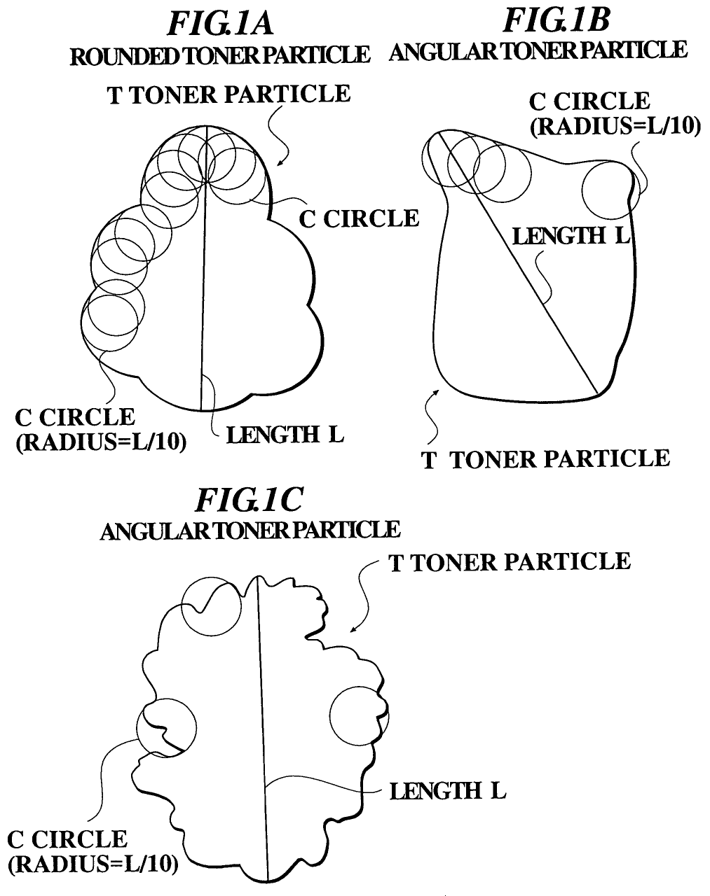

In the toner according to the present invention, the term “rounded toner particles” is intended to mean toner particles having substantially no protruding portions. More specifically, referred to as “rounded toner particles” are the toner particles defined as follows: As shown in FIG. 1A, assuming that a length of a toner particle T is represented by L, when a circle C having a radius (L/10) is rolled along the inside of the line of the periphery of the toner particle T in a state brought into contact with the line from inside at one point, if the circle C does not substantially protrude out of the toner particle T, the toner particle T is referred to as “rounded toner particle”. A case in which “the circle C does not substantially protrude out of the toner particle T” indicates a case in which there is one or less protrusion where the circle C protrudes out of the toner particle T.

Further, “length of a toner particle” indicates the width of a toner particle which maximizes a distance between two parallel lines sandwiching a projection image of the toner particle, projected onto a plane.

It should be noted that FIG. 1B and FIG. 1C show projection images of angular toner particles, respectively.

In the present invention, the ratio of rounded toner particles is measured as follows:

First, an enlarged photograph of a toner particle is taken by the scanning electron microscope, and then the photograph is further enlarged to obtain a photographic image magnified up to 15,000 times. Thereafter, it is determined whether or not the photographic image has corners. The determining operation is carried out on 1000 toner particles.

It is preferred that the ratio of toner particles having a volume average particle diameter of 2.5 μm is 10 volume % or less.

The reason for this is not clear, but it is presumed that since a small-sized component formed by small particles having a volume average particle diameter of 2.5 μm or less is very adhesive and small heat capacity, the adhesive stress ratio of the toner can be controlled to a value within the predetermined range by reducing the content of the small-sized component in the toner.

In the present invention, the ratio of the toner particles having a volume average particle diameter of 2.5 μm was measured by using the flow-type particle image analyzer FPIA-2000 (available from Toa Medical Electronics Co., Ltd.).

It is preferred that the toner according to the present invention is formed by adding a small-sized external additive (external additive having a small particle diameter), and more particularly by adding a small-sized external additive and an external additive having a large particle diameter (hereinafter also referred to as a “large-sized external additive”), with these external additives being mixed by a multiple-step mixing method in which the small-sized external additive and the large-sized external additive are added to be mixed therein, in the mentioned order.

The reason for this is presumed as follows: The small-sized external additive contributes to enhanced fluidity of the toner itself, whereas the large-sized external additive has a so-called spacing effect for reducing adhesion between toner particles. By using the two types of external additives in combination, it is possible to simultaneously impart an adhesion-reducing effect and a heat-blocking effect to the toner, thereby making it possible to control the adhesive stress ratio of the toner to a value within the predetermined range.

Although in the toner according to the present invention, it is preferred that the external additives are caused to uniformly adhere to surfaces of colorant particles, when a plurality of particles having different diameters (hereinafter also referred to as “multi-diameter particles”) are used in combination as external additives, different stresses are applied to the external additives due to different fluidities of the above particles, which makes it impossible to cause the multi-diameter particles forming the external additives to uniformly adhere to the surfaces of the toner particles, even if they are mixed under predetermined conditions. Therefore, it is preferred to employ the multiple-step mixing method in which the small-sized external additive is added to the toner to be mixed therein, and then the large-sized external additive is added to the toner, to be mixed therein.

More specifically, since the small-sized external additive exhibits a high cohesiveness between particles forming the same, it is necessary to loosen the aggregation of the particles to some degree, whereas when the large-sized external additive and the small-sized external additive are simultaneously added to the toner for mixing, particles of the small-sized external additive adhere to surfaces of particles of the large-sized external additive, resulting in the degraded capability of the large-sized external additive for imparting the spacing effect. Therefore, it is considered that by first adding the small-sized external additive for mixing, to loosen the aggregation to thereby increase fluidity, and then adding the large-sized external additive having a lower cohesiveness than the small-sized external additive for mixing, it is possible to cause the external additives comprised of the small-sized external additive and the large-sized external additive to uniformly adhere to the surfaces of the colorant particles.

It is preferred that the amount of the small-sized external additive added to the toner is 0.1 to 5.0 mass % with respect to the colorant particles.

Preferably, the amount of the large-sized external additive added to the toner is 0.1 to 5.0 mass % with respect to the colorant particles.

Further, when the small-sized external additive and the large-sized external additive are used in combination as the external additives, it is preferable to add 0.3 to 1.5 parts by mass of the small-sized external additive with respect to 1 part by mass of the large-sized external additive.

A surface coverage of an external additive on a surface of a toner particle is 40 to 100%, and preferably 50 to 100%.

When the surface coverage is smaller than 40%, the advantageous effect of the external additive is not sufficiently exhibited in a toner obtained, whereas when the surface coverage exceeds 100%, there occurs liberation of the external additive, which can cause damage to an electrostatic latent image carrier.

It should be noted that a state where the surface coverage exceeds 100% indicates a state where the external additive has adhered to a whole periphery of a colorant particle, and at the same time the external additive exists in the form of multiple layers.

The surface coverage is for evaluating a state of presence of the external additive adhering to a surface of a colorant particle. The surface coverage is obtained by slicing a sample formed by enclosing toner particles having an external additive added thereto with an epoxy resin, to a thickness of 0.2 μm, observing the obtained slice using a transmission electron microscope to thereby measure a length of periphery of a portion of the colorant particle where the external additive adheres, and calculating a ratio of a value of the measured length to a length of the whole periphery of the portion of the colorant particle.

The small-sized external additive is an additive comprised of particles whose number average primary particle diameter is 30 nm or less, and preferably 5 to 25 nm. Further, it is preferable to use not only the small-sized external additive but also an external additive having a number average primary particle diameter of preferably 15 to 70 nm, more preferably 20 to 50 nm, which is larger in particle diameter than the small-sized external additive.

Preferably, the small-sized external additive is comprised of inorganic fine particles. Further, it is preferable that surfaces of the particles thereof are subjected to hydrophobic treatment.

The number average primary particle diameter indicates a value thereof obtained by observing 100 particles magnified up to 2000 times by the transmission electron microscope, and carrying out image analysis on the particles for measurement.

As materials forming the inorganic fine particles of the small-sized external additive, there can be suitably used inorganic oxides, nitrides, borides, and the like.

Examples of the inorganic oxides include silica, alumina, titania, zirconia, barium titanate, aluminum titanate, strontium titanate, magnesium titanate, zinc oxide, chromium oxide, ceric oxide, antimony oxide, tungstic oxide, tin oxide, tellurium oxide, manganese oxide, boron oxide, silicon carbide, boron carbide, titanium carbide, silicon nitride, titanium nitride, and boron nitride.

Preferably, the hydrophobic treatment on the inorganic fine particles is carried out by using, as treatment agents, so-called coupling agents, such as titanium coupling agents and silane coupling agents, silicone oil, and metal salts of higher fatty acids, such as aluminum stearate, zinc stearate, and calcium stearate.

Examples of the titanium coupling agents include tetrabutyl titanate, tetraoctyl titanate, isopropyl triisostearoyl titanate, isopropyl tridecylbenzenesulfonyl titanate, and bis(dioctyl pyrophosphate)oxyacetate titanate.

Examples of the silane coupling agents are γ-(2-aminoethyl)aminopropyl-trimethoxysilane, γ-(2-aminoethyl)aminopropyl-methyldimethoxysilane, γ-methacryloxy-propyl-trimethoxysilane, N-β-(N-vinylbenzil aminoethyl) γ-aminopropyl-trimethoxysilane hydrochloride, hexamethyldisilazane, methyltrimethoxysilane, butyltrimethoxysilane, isobutyltrimethoxysilane, hexyltrimethoxysilane, octyltrimethoxysilane, decyltrimethoxysilane, dodecyltrimethoxysilane, phenyl rimethoxysilane, o-methylphenyltrimethoxysilane, and p-methylphenyltrimethoxysilane.

Examples of the fatty acids include long-chain fatty acids, such as undecylic acid, lauric acid, tridecylic acid, dodecyl acid, myristic acid, palmitic acid, pentadecylic acid, stearic acid, heptadecylic acid, arachic acid, montanic acid, oleic acid, linoleic acid, and arachidonic acid. Further, examples of metal salts of fatty acids are salts formed by the above-mentioned fatty acids and metals, such as zinc, iron, magnesium, aluminum, calcium, sodium, and lithium.

Examples of the silicone oil include dimethyl silicone oil, methyl phenyl silicone oil, and amino-modified silicone oil.

The above compounds forming the treatment agents can be used alone or in combination of two or more, as required.

Preferably, the amount of one or more treatment agents added to the toner is 1 to 10 mass %, more preferably 3 to 7 mass %, with respect to inorganic fine particles.

Out of the above inorganic fine particles, silica, titania, alumina, and zirconia are preferably used as small-sized external additives.

The large-sized external additive is an additive comprised of particles whose number average primary particle diameter is 100 nm or more, preferably 100 to 2000 nm, more preferably 150 to 1000 nm.

The large-sized external additive may be comprised of any of inorganic fine particles, organic fine particles, and composite fine particles. Preferably, surfaces of particles of the large-sized external additive are subjected to hydrophobic treatment.

The number average primary particle diameter indicates a value thereof obtained by observing 100 particles magnified up to 2000 times by the transmission electron microscope, and carrying out image analysis on the particles for measurement.

As materials forming the inorganic fine particles of the large-sized external additive, there can be suitably used materials which have been described above as materials forming particles of the small-sized external additive.

Out of the inorganic fine particles, titania, zirconia, alumina, silica, strontium titanate, barium titanate, and calcium titanate are preferably used as large-sized external additives.

Examples of the organic fine particles are used resin particles, such as styrene resin particles, styrene-acrylic resin particles, polyester resin particles, and urethane resin particles.

Although the composition of the resin particles forming the organic fine particles is not particularly limited, vinyl-based organic fine particles are preferably used since they can be manufactured easily by manufacturing methods, such as an emulsion polymerization method or a suspension polymerization method.

Out of the organic fine particles, acrylic resin particles, styrene-acrylic resin particles, and silicone resin particles are preferably used as the large-sized external additives.

The resin particles forming the organic fine particles can be produced by a polymerization method, such as the emulsion polymerization or the suspension polymerization method.

The emulsion polymerization method is a method in which any of the above monomers is added to water containing a surfactant, such as sodium dodecyl benzene sulfonate, polyvinyl alcohol, ethyleneoxide adduct, or sodium higher alcohol sulfate, for emulsification, and then polymerization of the monomer is performed.

Further, the resin particles forming the organic fine particles can also be suitably manufactured by a so-called emulsifier-free polymerization method, such as a method employing a reactive emulsifier, such as sulfonates of acrylic acid amide and salts of maleic acid derivatives, a method of polymerizing hydrophilic monomers, such as vinyl acetate and methyl acrylate, using a persulfate-based initiator, a method of copolymerizing water-soluble monomers, a method using water-soluble resins or oligomers, a method using a decomposition emulsifier, and a method using a crosslinking emulsifier. This emulsifier-free polymerization method is suitable especially when organic fine particles are used singly, since resin particles are free from adverse effects of a residual emulsifier.

Examples of monomers required to synthesize resin particles forming the organic fine particles by polymerization are vinyl-based monomers, such as styrenes and styrene derivatives, including styrene, α-methylstyrene, p-chlorostyrene, 3,4-dichlorostylene, p-phenylstyrene, p-ethylstyrene, 2,4-dimethylstyrene, and p-t-butylstyrene, methacrylate derivatives including methyl methacrylate, ethyl methacrylate, n-butyl methacrylate, isopropyl methacrylate, and 2-ethylhexyl methacrylate, acrylate derivatives including methyl acrylate, ethyl acrylate, isopropyl acrylate, n-butyl acrylate, t-butyl acrylate, isobutyl acrylate, n-octyl acrylate, and 2-ethylhexyl acrylate, olefins including ethylene, propylene, and isobutylene, halogen-based vinyls including vinyl chloride, vinylidene chloride, vinyl bromide, vinyl fluoride, and vinylidene fluoride, vinyl esters including vinyl propionate, and vinyl acetate, vinyl ethers including vinyl methylether, and vinyl ethylether, vinyl ketones including vinyl methylketone, vinyl ethylketone, and vinyl hexylketone, N-vinyl compounds including N-vinyl carbazole, N-vinyl indole, and N-vinyl pyrrolidone, vinyl compounds including vinyl naphthalene, and vinyl pyridine, acrylic acid or methacrylic acid derivatives including acrylonitrile, methacrylonitrile, acrylamide, N-butyl acrylamide, N, N-dibutyl acrylamide, methacrylamide, N-butyl methacrylamide, and N-octadecyl acrylamide.

The above vinyl-based monomers can be used alone or in combination of two or more, as required.

Examples of the polymerization initiators required for synthesizing resin particles forming the organic fine particles by polymerization include peroxides, such as benzoyl peroxide, and lauryl peroxide, and azo-based polymerization initiators, such as azobisiso butyronitrile, and azobisiso valeronitrile.

Preferably, the amount of a polymerization initiator added is 0.1 to 2 mass % with respect to the amount of the monomer.

When the mount of the polymerization initiator added is too small, polymerization reaction cannot be sufficiently carried out, so that there is a fear that the monomer remains in an reaction product obtained. On the other hand, when the mount of the polymerization initiator added is too large, there is a fear that decomposed products of the polymerization initiator remain in an reaction product obtained, which hinders the toner from having an appropriate electric chargeability, and further, the rate of the polymerization reaction is increased to reduce the molecular weight of the reaction product obtained.

Further, in the emulsion polymerization or the like, potassium persulfate and sodium thiosulfate, for example, can be used as polymerization initiators.

The term “composite fine particle” is intended to mean a particle in which inorganic fine particles are stuck to surfaces of a resin fine particle (hereinafter also referred to as a “core resin fine particle”) serving as a core.

The composite fine particles can be manufactured e.g. by a method in which first, inorganic fine particles are added to and mixed with core resin fine particles, and electrostatically attached to surfaces of the core resin fine particles to form an ordered mixture, and then mechanical energy is applied to the ordered mixture, thereby the inorganic fine particles to be stuck to the surfaces of the core resin fine particles.

Now, the terms “sticking” and “stuck” used in describing this feature of the invention is intended to express a state in which a ration of sticking (see Japanese Laid-Open Patent Publication (Kokai) No. 4-291352) is 25% or more.

The “ration of sticking” is concerned with a state of inorganic fine particles being stuck to surfaces of core resin fine particles, and defines a state of the inorganic fine particles being buried in the core resin fine particles. More specifically, the ratio of sticking is calculated using the following Equation (3):

$$ratio of sticking = ( 1 - \frac{S h}{( 1 - x ) \times S a + x \times S b} ) \times 100 \qquad ( 3 )$$

wherein Sa represents a specific surface area of core resin fine particles, Sb represents a specific surface area of inorganic fine particles, Sh represents a specific surface area of composite fine particles after the inorganic fine particles have been stuck to the surfaces of the core resin fine particles, and x represents a ratio of addition of the inorganic fine particles to the core resin fine particles.)

It is preferable that the ration of sticking is equal to or larger than 25% and smaller than 100%, particularly 40% to 80%.

When the ration of sticking is smaller than 25%, a degree of sticking of the inorganic fine particles to the core resin fine particles is lowered, causing liberation of the inorganic fine particles which exist on the surfaces of the core resin fine particles, and if composite fine particles are repeatedly used for a long time period, the liberation of inorganic fine particles can cause undesired damage to the electrostatic latent image carrier.

It should be noted that the ration of sticking can be adjusted variously by controlling sticking conditions by a manufacturing device that causes the fine particles to be stuck.

The ratio of the inorganic fine particles to the core resin fine particles, forming the composite fine particles, depends on the respective particle diameters, and it is only required that the inorganic fine particles are added in such an amount as will uniformly cover the core resin fine particles. More specifically, normally, it is preferable that the ratio of the inorganic fine particles to the core resin fine particles is 5 to 30 mass %.

Preferably, the ordered mixture is formed at an atmospheric temperature equal to or lower than a temperature Tg (glass transition temperature) of a resin forming the surfaces of the core resin fine particles. This is because when the atmospheric temperature is excessively high, coalescence of core resin fine particles is caused.

Further, the ordered mixture can be formed using an apparatus, such as a Henschel mixer, an OM. dizer, a Turbula mixer, a Loedige mixer, or a V-type mixer, which is capable of electrostatically uniformly attaching the inorganic fine particles to the surfaces of the core resin fine particles.

As a mechanical energy applying apparatus for causing the inorganic fine particles electrostatically attached to the surfaces of the core resin fine particles, to be stuck to the core resin fine particles, it is possible to use a “Hybridizer” (available from Nara Machinery Co., Ltd.), which is a modification of an impact pulverizer, “free mill” (available from Nara Machinery Co., Ltd.), an “ong mill” (available from Hosokawa Micron Corporation), a “Criptron” (Kawasaki Heavy Industries, Ltd.), and the like.

In causing the inorganic fine particles to be stuck to the surfaces of the core resin fine particles using the apparatus described above, it is possible not only to apply mechanical energy to the ordered mixture but also to heat or cool the core resin fine particles from outside. More specifically, when a mechanical impact force is applied in an apparatus rotating at a high speed, the temperature inside the apparatus (internal temperature) is raised by energy of collision of particles. At this time, when the internal temperature becomes higher than the temperature Tg (glass transition temperature) of the core resin fine particles, there is a fear that the inside of the core resin fine particle is fused to form agglomerated particles, so that the core resin fine particles are required to be cooled for control of the temperature. On the other hand, when internal temperature is lower than the temperature Tg by 30° C. or more, an excessively large amount of the energy is required for causing the inorganic fine particles to be stuck to the core resin fine particle, thereby increasing the energy of collision of particles. This can lead to pulverization of the core resin fine particle, so that the internal temperature is required to be raised approximately up to the temperature Tg. In this case, it is necessary to perform heating from outside.

To control the internal temperature from outside, it is preferable to employ a method of controlling the temperature by circulating a heated medium through a jacket provided outside the apparatus. The internal temperature is measured by a temperature of circulating air detected by a thermometer disposed at a location where the inorganic fine particles are caused to be stuck to the core resin fine particles.

It should be noted that water or oil can be used as the medium.

Although the core resin fine particles are not particularly limited, it is preferable to use core resin fine particles formed by a vinyl-based polymer.

Examples of a monomer used for obtaining core resin fine particles include aromatic vinyl monomers, (meth)acrylate monomers, vinyl ester monomers, vinyl ether monomers, monoolefin monomers, diolefin monomers, and halogenated olefin monomers.

Examples of the aromatic vinyl monomers include styrene monomers and derivatives thereof, such as styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, and 3,4-dichlorostyrene.

Examples of the (meth)acrylate monomers are methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl β-hydroxyacrylate, propyl γ-aminoacrylate, stearyl methacrylate, dimethylaminoethyl methacrylate, and diethylaminoethyl methacrylate.

Examples of the vinyl ester monomers include vinyl acetate, vinyl propionate, and vinyl benzoate.

Examples of the vinyl ether monomers include vinylmethylether, vinylethylether, vinylisobutylether, and vinylphenylether.

Examples of the monoolefin monomers include ethylene, propylene, isobutylene, 1-butene, 1-pentene, and 4-methyl-1-pentene.

Examples of the diolefin monomers include butadiene, isoprene, and chloroprene.

Examples of the halogenated olefin monomer include vinyl chloride, vinylidene chloride, and vinyl bromide.

To add an external additive to colorant particles, there is employed a method of adding the external additive to a system charged with the colorant particles, and mixing the colorant particles and the external additive with stirring.

To mix the colorant particles and the external additive with stirring, a mechanical rotation processing apparatus is preferably used. More specifically, a rotation-type mixer, such as the Henschel mixer, is suitably used.

It is preferable that an addition process by such an apparatus is carried out at a stirring speed which causes distal ends of stirring blades disposed in the apparatus to rotate at a speed (peripheral speed) of 30 to 80 m/sec, more preferably 35 to 60 m/sec. This is because when the rotational speed is too high, the mixing-with-stirring process accelerates burial of the external additive into the colorant particles, resulting in the increased adhesive stress of a toner obtained.

Further, in the addition process, it is important to control processing energy within the apparatus. The energy control can be carried out by adjusting the degree of occupation by the toner (loading amount of the toner), i.e. the amount of materials to be processed (components of the toner), charged within the apparatus.

More specifically, e.g. when the Henschel mixer is used as a mixing machine, it is preferable that a volume/capacity ratio, which indicates the ratio of a volume occupied by a material to be processed to the capacity of the mixer, is set to 30 to 80%, more preferably 40 to 70%.

The “volume/capacity ratio” is intended to mean a value obtained by dividing a volume of the material to be processed, calculated based on the static bulk density thereof by the capacity of the apparatus, the value being expressed in percentage.

Further, when a small-sized external additive and a large-sized external additive are added as external additives by a multi-step mixing method, it is preferable that a first-stage mixing-with-stirring process is carried out at a stirring speed of 30 to 80 m/sec, for a stirring time period of 30 seconds to 10 minutes, and further, a second or latter-stage stirring/mixing process is carried out at a stirring speed of 30 to 80 m/sec, for a stirring time period of 10 seconds to 60 minutes.

Preferably, the toner according to the present invention has a volume average particle diameter of 3 to 9 μm, more preferably 4.5 to 8.5 μm.

The volume average particle diameter can be measured e.g. by using a “Coulter Counter TA-II”, a “Coulter Multisizer” (both of which are available from Coulter Electronics Inc.), or a laser diffraction-type particle diameter measuring apparatus “SLAD1100” (available from Shimadzu Corporation).

In the present invention, the volume average particle diameter is measured using the “Coulter Counter TA-II” connected to an interface (available from Nikkaki-bios Co., Ltd.) and calculated by a personal computer which outputs a particle diameter distribution.

In a molecular weight distribution measured by GPC (gel permeation chromatography), the toner according to the present invention has peaks or shoulders preferably in a range of 100,000 to 1,000,000 and a range of 1,000 to 50,000, more preferably in the range of 100,000 to 1,000,000, a range of 25,000 to 150,000, and the range of 1,000 to 50,000.

The molecular weight of a resin is measured by GPC by the following method: One ml of tetrahydrofuran (THF) is added to 0.5 to 5.0 mg (specifically 1 mg) of a sample, and the sample is fully dissolved by stirring the mixture at room temperature using a magnetic stirrer or the like. Then, the mixture is filtered through a membrane filter having a pore size of 0.45 to 0.50 μm, and then injected into GPC.

The molecular weight of the sample is measured by GPC under conditions that columns are stabilized at 40° C., THF is caused to flow at a flow rate of 1 ml per minute, and an approximately 100 μl of the sample having a concentration of 1 mg/ml is injected for measurement. It is preferable to use a combination of commercially available polystyrene gel columns. For example, there may be used a combination of Shodex GPC KF-801, 802, 803, 804, 805, 806, 807, available from Showa Denko Company, and a combination of TSKgel G1000H, G2000H, G3000H, G4000H, G5000H, G6000H, G7000H, and TSK guard column, available from Tosoh Corporation. Further, as a detector, a refractive index detector (IR detector), or a UV detector is conveniently used. In measuring the molecular weight of the sample, the molecular weight distribution of the sample is calculated using a calibration curve prepared using monodisperse polystyrene standard particles. It is advisable to use about ten kinds of polystyrene for preparing the calibration curve.

The toner according to the present invention is made by adding an electric charge control agent to resin particles as required, then adding colorant particles, an organic solvent, and a flocculant, such as salts, to the mixture to thereby salt-out/fuse the resin particles and the colorant agents in a water-base medium. This method is not particularly limited, but disclosed e.g. in Japanese Laid-Open Patent Publications (Kokai) No. 5-265252, No. 6-329947, and No. 9-15904. More specifically, the toner according to the present invention can be formed by a method of associating a plurality of disperse particles of component materials, such as resin particles and a colorant, or a plurality of fine particles comprised of a resin and a colorant, particularly, by dispersing these particles in water using an emulsifier, then adding a flocculent having a concentration higher than a critical flocculation concentration to the dispersion, for salting out, and at the same time, heating the thus formed polymer at a temperature higher than a glass transition temperature of the polymer itself to fuse particles to each other to thereby grow the particles such that the particle diameter thereof is gradually increased, stopping increasing the particle diameter by adding a large amount of water thereto when a desired particle diameter is reached, further controlling the shape of particles by heating and stirring the mixture such that the particle surface becomes smooth, and heating the particles still hydrous in a flowable state to dry the same. It should be noted that when the flocculant is added, a solvent which is infinitely soluble to water may be added.

As the resin particles, particles of a resin containing at least two components, i.e. a high molecular weight component having peaks or shoulders in a range of 100,000 to 1,000,000, and a low molecular weight component having peaks or shoulders in a range of 1,000 to less than 50,000, are preferable, and particles of a resin additionally having a medium molecular weight resin having peaks or shoulders in a range of 15,000 to 100,000 are more preferable.

Preferably, the resin particles have a softening point of 90 to 140° C.

The resin particles can be prepared by subjecting a polymerizable monomer to a polymerization process in a water-base medium, e.g. by a granulation polymerization method, such as an emulsification polymerization method. As the polymerizable monomer used for obtaining the resin particles, a radical polymerizable monomer is an essential component, and a cross-linkable monomer (crosslinker) may be used as required. Further, it is preferable that polymerizable monomer contains at least one kind of radical polyemeriable monomer having an acidic group or a basic polymerizable monomer having a basic group.

(1) Radical Polymerizable Monomers

The radial polymerizable monomers are not particularly limited, but conventionally known radical polymerizable monomers can be used. Further, it is possible to use one kind of monomer or a combination of two or more kinds of monomers so as to satisfy the required characteristics.

More specifically, monomers enumerated as those for obtaining core resin particles forming composite fine particles can be used as the radical polymerizable monomers.

(2) Crosslinkable Monomers

To improve characteristics of a toner as a final product, a radical polymerizable crosslinking agent may be added as a crosslinkable monomer. Examples of the radical polymerizable crosslinking agent include monomers having two or more unsaturated bonds, such as divinyl benzene, divinyl naphthalene, divinyl ether, diethyleneglycol methacrylate, ethyleneglycol dimethacrylate, polyethyleneglycol dimethacrylate, and diallyl phthalate.

(3) Radical Polymerizable Monomers Having an Acidic Group

Examples of the radical polymerizable monomers having an acidic group include α,β-ethylenic unsaturated monomers having a carboxyl group (—COOH), and α,β-ethylenic unsaturated monomers having a sulfonic acid group (—SO₃H).

Examples of the α,β-ethylenic unsaturated monomers having a carboxyl group (—COOH) include acrylic acid, methacrylic acid, fumaric acid, maleic acid, itaconic acid, cinnamic acid, monobutylester maleate, monooctylester maleate, and metal salts thereof, such as sodium (Na) and zinc (Zn) slats thereof.

Examples of the α,β-ethylenic unsaturated monomers having a sulfonic acid group (—SO₃H) include sulfonated styrene and sodium salts thereof, allyl sulfosuccinate, octylallyl sulfosuccinate, and sodium salts these.

(4) Radical Polymerizable Monomers Having a Basic Group

Examples of the radical polymerizable monomers having a basic group include (a) (meth)acrylates of aliphatic alcohols having an amine group or a quaternary ammonium group, and having 1 to 12 carbon atoms, preferably 2 to 8 carbon atoms, particularly preferably 2 carbon atoms, (b) (meth)acrylic acid amides, or mono- or di-alkyl-substituted (meth)acrylic acid amides substituted on an arbitrary N atom with an alkyl group having 1 to 18 carbon atoms, (c) vinyl compounds substituted with heterocyclic rings having an N atom as a ring member, (d) N, N-diallyl-alkylamines, or quaternary ammonium salts thereof. Among these, (a) (meth)acrylates of aliphatic alcohols having an amine group or a quaternary ammonium group are preferable as the monomers having a basic group.

Examples of (a) (meth)acrylates of aliphatic alcohols having an amine group or a quaternary ammonium group include dimethylaminoethyl acrylate, dimethylaminoethyl methacrylate, diethylaminoethyl acrylate, diethylaminoethyl methacrylate, quaternary ammonium salt of the above four compounds, 3-dimethylaminophenyl acrylate, and 2-hydroxy-3-methacryloxypropyltrimethylammonium salt.

Examples of (b) (meth)acrylic acid amides, or mono- or di-alkyl-substituted (meth)acrylic acid amides substituted on an arbitrary N atom with an alkyl group having 1 to 18 carbon atoms include acrylamide, N-butyl acrylamide, N, N-dibutyl acrylamide, piperidyl acrylamide, methacrylamide, N-butyl methacrylamide, N, N-dimethyl acrylamide, and N-octadecyl acrylamide.

Examples of (c) vinyl compounds substituted with a heterocyclic ring having an N atom as a ring member include vinylpyridine, vinylpyrrolidone, vinyl-N-methylpyridinium chloride, and vinyl-N-ethylpyridinium chloride.

Examples of (d) N, N-diallyl-alkylamines include N, N-diallyl-methylammonium chloride, and N, N-diallyl-ethylammonium chloride.

In order to adjust the molecular weight of resin particles, a known chain transfer agent can be used.

The chain transfer agent is not particularly limited, but mercapto compounds having a mercapto group, such as octyl mercaptan, dodecyl mercaptan, and tert-dodecyl mercaptan, are used. Particularly, mercapto compounds having a short molecular chain are preferably used, since the use thereof makes it possible to obtain a toner which is suppressed in generation of odor during heating and fixing operations, sharp in molecular weight distribution, and excellent in preservability, fixation strength, and an anti-offsetting property.

Examples of preferable chain transfer agents include propyl thioglycolate, octyl thioglycolate, n-octyl mercaptopropionate, and octyl mercaptan.

In the present invention, any suitable radical polymerization initiators can be used as so long as they are water-soluble. For example, persulfates (potassium persulfate, ammonium persulfate, etc.), azo compounds (4, 4′-azobis(4-cyanovaleric acid) and salts thereof, 2,2′-azobis(2-amidinopropane) and salts thereof, etc.), and peroxide compounds can be used as the radical polymerization initiators.

Further, the radical polymerization initiators can be used as Redox initiators by using them in combination with reducing agents as required. By using the Redox initiators, polymerization activity is increased, whereby it is possible to lower a polymerization temperature, and hence shortening of a polymerization time period can be expected.

Although any temperature may be selected as the polymerization temperature so long as it is equal to or higher than a lowest radical forming temperature, a temperature within a range of 50 to 90° C. is used. However, when a polymerization initiator for starting polymerization at an ordinary temperature, e.g. a combination of hydrogen peroxide-reducing agent (e.g. ascorbic acid) is used, it is also possible to carry out polymerization at room temperature, or a temperature equal to or higher than the room temperature.

To perform polymerization by using the radical polymerizable monomers described above, it is preferable to disperse oil drops in a water-base medium using a surfactant. The surfactants usuable in the present invention are not particularly limited, but the following are examples of suitable ionic surfactants.

Examples of the ionic surfactants include sulfonates (sodium dodecylbenzenesulfonate, sodium aryl alkyl polyethersulfonate, sodium 3,3-disulfondiphenylurea-4,4-diazo-bis-amino-8-naphthol-6-sulfonate, sodium ortho-caroxybenzene-azo-dimethylaniline-2,2,5,5-tetramethyl-triphenylmetha ne-4,4-diazi-bis-β-naphthol-6-sulfonate, and the like), sulfates (sodium dodecyl sulfate, sodium tetradecyl sulfate, sodium pentadecyl sulfate, sodium octyl sulfate, etc.), fatty acid salts (sodium oleate, sodium laurate, sodium caprate, sodium caprylate, sodium caproate, potassium stearate, calcium oleate, and the like.).

Further, nonionic surfactants as well can be used. Examples of the nonionic surfactants include polyethylene oxide, polypropylene oxide, a combination of polypropylene oxide and polyethylene oxide, esters of polyethylene glycol with higher fatty acids, alkylphenol polyethylene oxide, esters of polypropylene oxide with higher fatty acids, and sorbitan esters.

The toner according to the present invention may be comprised of resin particles (hereinafter referred to as the “release agent-containing resin particles”) which contain, as required, a crystalline material (hereinafter, simply referred to as a “release agent”) having releasing properties and serving as a fixation-improving agent.

The release agent is not particularly limited, but polyolefin wax, such as low molecular weight polypropylene and low molecular weight polyethylene, paraffin wax, Fischer-Trosch wax, ester wax, and the like, can be used as the release agent. An ester compound represented by the following general formula (A) is preferably used.

R¹—(OCO—R²)ₙ (A)

wherein, R¹ and R² represent hydrocarbon groups which may have substituents, respectively, and n designates an integer defined as 1≦n≦4).

In the general formula (A), R¹ and R² represent hydrocarbon groups which may have substituents, respectively. The hydrocarbon group R1 has 1 to 40 carbon atoms, preferably 1 to 20 carbon atoms, more preferably 2 to 5 carbon atoms. Further, the hydrocarbon group R2 has 1 to 40 carbon atoms, preferably 16 to 30 carbon atoms, and more preferably 18 to 26 carbon atoms.

The hydrocarbon group R¹ and the hydrocarbon group R² may be identical to or different from each other.

Further, In the general formula (A), n designates an integer defined as 1≦n≦4, preferably 2≦n≦4), and more preferably 3≦n≦4, particularly preferably 4.

Examples of the ester compound include those represented by the following formulas (W1) to W(22):

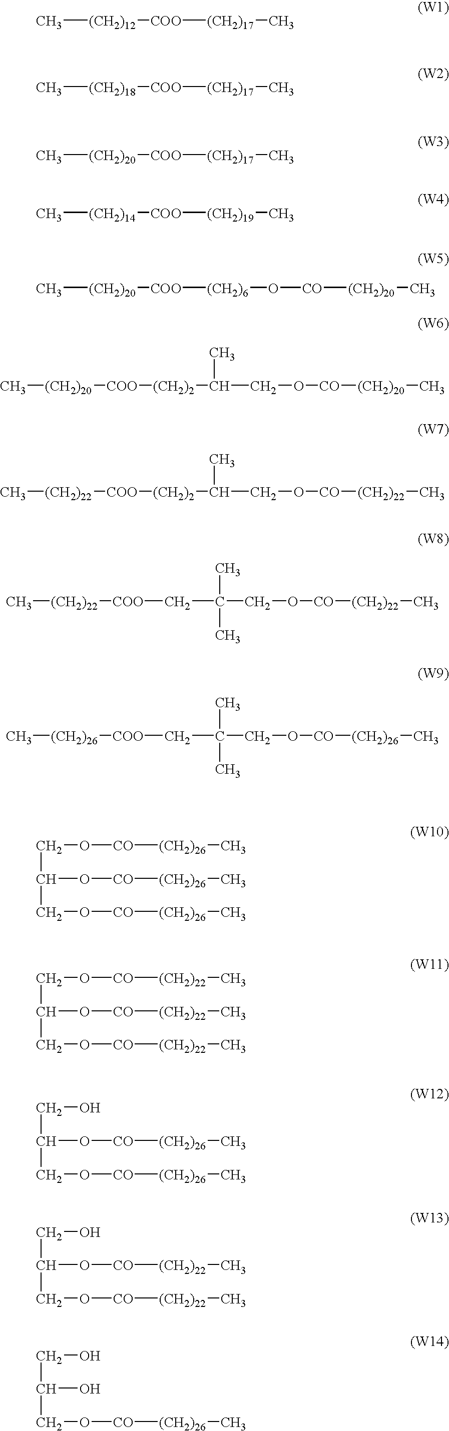

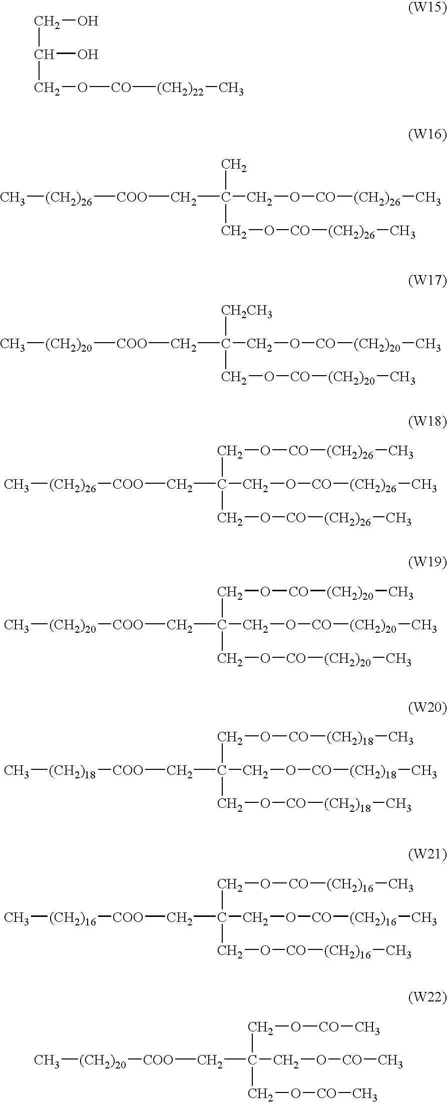

The content of the release agent with respect to whole of the toner is normally 1 to 30 mass %, preferably 2 to 20 mass %, more preferably 3 to 15 mass %.

Although in the present invention, the “release agent-containing resin particles” can be also obtained by the technique of adding release agent particles during execution of salting-out/fusing, it is preferable that the release agent-containing resin particles are obtained by dissolving a release agent at least in a polymerizable monomer, carrying out a step of polymerizing the polymerizable monomer having the release agent contained therein, and salting-out and fusing the resultant composite resin particles and colorant particles.

A preferable polymerization method for obtaining resin particles having a release agent contained therein includes a radical polymerization method (hereinafter referred to as the “mini-emulsion method” in the present specification), in which in a water-base medium having a surfactant with a concentration equal to or lower than a critical micelle concentration, dissolved therein, a monomer solution formed by dissolving a release agent in a polymerizable monomer is dispersed in the form of oil droplets (10 to 1,000 nm) by using mechanical energy, to prepare a dispersion, and a polymerization initiator is added to the dispersion for carrying out radical polymerization of the polymerizable monomer. According to the mini-emulsion method, differently from the normal emulsion polymerization method, only a small amount of a release agent dissolved in the polymerizable monomer is liberated, so that it is possible to introduce a sufficient amount of the release agent into resin particles formed.

It should be noted that an oil-soluble polymerization initiator may be added to the monomer solution in place of or together with the water-soluble polymerization initiator.

A dispersing apparatus for conducting oil droplet dispersion by using mechanical energy is not particularly limited, but there may be used a mechanical dispersing apparatus “CLEARMIX” (available from M Technique Co., Ltd.) which is a stirring machine equipped with a rotor rotating at a high speed, an ultrasonic wave dispersing machine, a mechanical homogenizer, Manton Gaulin, or a pressure homogenizer.

As the colorants, there may be used, for example, magnetic powders, such as magnetite and ferrite, inorganic pigments, organic pigments, and dyes. As the inorganic pigments, the organic pigments, and the dyes, there can be used conventionally known pigments and dyes.

Further, it is possible to use colorants whose surfaces are modified.

Examples of black inorganic pigments include carbon black, such as furnace black, channel black, acetylene black, thermal black, and lampblack.

These inorganic pigments can be used alone or in combination of two or more, as required.

Further, the amount of an inorganic pigment added is 2 to 20 mass %, preferably 3 to 15 mass %, with respect to the amount of polymer (resin particles).

Examples of the organic pigments for magenta or red include C.I. pigment red 2, C.I. pigment red 3, C.I. pigment red 5, C.I. pigment red 6, C.I. pigment red 7, C.I. pigment red 15, C.I. pigment red 16, C.I. pigment red 48:1, C.I. pigment red 53:1, C.I. pigment red 57:1, C.I. pigment red 122, C.I. pigment red 123, C.I. pigment red 139, C.I. pigment red 144, C.I. pigment red 149, C.I. pigment red 166, C.I. pigment red 177, C.I. pigment red 178, and C.I. pigment red 222.

Examples of the organic pigments for orange or yellow include C.I. pigment orange 31, C.I. pigment orange 43, C.I. pigment yellow 12, C.I. pigment yellow 13, C.I. pigment yellow 14, C.I. pigment yellow 15, C.I. pigment yellow 17, C.I. pigment yellow 74, C.I. pigment yellow 94, C.I. pigment yellow 138, C.I. pigment yellow 180, C.I. pigment yellow 185, C.I. pigment yellow 155, and C.I. pigment yellow 156.

Examples of the organic pigments for green or cyan include C.I. pigment blue 15, C.I. pigment blue 15:2, C.I. pigment blue 15:3, C.I. pigment blue 16, C.I. pigment blue 60, and C.I. pigment green 7.

Further, examples of dyes include C.I. solvent red 1, C.I. solvent red 49, C.I. solvent red 52, C.I. solvent red 58, C.I. solvent red 63, C.I. solvent red 111, C.I. solvent red 122, C.I. solvent yellow 19, C.I. solvent yellow 44, C.I. solvent yellow 77, C.I. solvent yellow 79, C.I. solvent yellow 81, C.I. solvent yellow 82, C.I. solvent yellow 93, C.I. solvent yellow 98, C.I. solvent yellow 103, C.I. solvent yellow 104, C.I. solvent yellow 112, C.I. solvent yellow 162, and C.I. solvent blue 25, C.I. solvent blue 36, C.I. solvent blue 60, C.I. solvent blue 70, C.I. solvent blue 93, C.I. solvent blue 95, etc. It is also possible to use mixtures thereof.

The above organic pigments and dye materials can be used alone or in combination of two or more, as required.

Further, the amount of organic pigment added is 2 to 20 mass %, preferably 3 to 15 mass %, with respect to the amount of polymer (resin particles).

Next, the method for manufacturing the toner according to the present invention comprises, by way of example:

(1) a dissolving step of dissolving a release agent in a polymerizable monomer to thereby prepare a monomer solution,

(2) a dispersing step of dispersing the obtained monomer solution in a water-base medium,

(3) a polymerizing step of subjecting an aqueous dispersion system of the obtained monomer solution to polymerizing to thereby prepare a liquid dispersion (Latex) of resin particles containing the release agent,

(4) a salting-out/fusing step of obtaining toner particles by salting-out/fusing the obtained resin particles and colorant particles in the water-base medium,

(5) a filtering/washing step of separating the obtained toner particles from the water-base medium by filtration, and washing the toner particles to thereby remove a surfactant and the like therefrom, and

(6) a drying step of drying the washed toner particles,

the method may further comprise (7) an external additive-adding step of adding an external additive to the dried toner particles.

(1) Dissolving Step

The method of dissolving a release agent in polymerizable monomer is not particularly limited.

It should be noted that an oil-soluble polymerization initiator and other oil-soluble constituents can be added to the monomer solution.

(2) Dispersing Step

Although the method of dispersing the obtained monomer solution in a water-base medium is not particularly limited, it is preferable to employ a method of dispersing the obtained monomer solution by mechanical energy. Particularly, it is preferable to carry out oil droplet dispersion of the monomer solution in a water-base medium formed by dissolving a surfactant to a concentration not higher than a critical micelle concentration, by making use of mechanical energy. This manner of dispersion is essential to the mini-emulsion method.

(3) Polymerizing Step

In the polymerizing step, there may be employed, basically, a granulation polymerization method, including the emulsion polymerization method, the suspension polymerization method, and a seed polymerization method, and an example of a preferable polymerization method is the mini-emulsion method.

(4) Salting-Out/Fusing Step

In the salting-out/fusing step, a liquid dispersion of colorant particles is added to the liquid dispersion of the resin particles obtained in the polymerizing step, thereby salting-out/fusing the resin particles and the colorant particles in the water-base medium.

Further, in the salting-out/fusing step, not only the resin particles and the colorant particles but also internal additive particles (fine particles having a mass average primary particle diameter of approximately 10 to 1000 nm) e.g. of a charge-controlling agent can be fused.

Now, the term “salting-out/fusing” is intended to mean simultaneous occurrence of salting-out (aggregation of particles) and fusing (extinction of interfaces between particles), or action for causing salting-out and fusing to occur simultaneously. To cause the salting-out and the fusing to occur at the same time, it is required to aggregate particles (resin particles, colorant particles) at a temperature equal to or higher than a glass transition temperature (Tg) of a resin constituting resin particles.

In the salting-out/fusing step, the term “water-base medium” is intended to mean a medium mainly composed of water (50 mass % or more). The components other than water include water-soluble organic solvents, such as methanol, ethanol, isopropanol, butanol, acetone, methyl ethyl ketone, and tetrahydrofuran. Out of the above organic solvents, alcohol-based organic solvents, such as methanol, ethanol, isopropanol, butanol, which do not dissolve any resins, are particularly preferable.

The liquid dispersion of the resin particles used in the salting-out/fusing step can be obtained by a method of repeatedly dispersing resin particles by using energy made uniform through mechanical dispersion of the resin particles by a pressure dispersing machine, such as the mechanical dispersing apparatus “CLEARMIX” (available from M Technique Co., Ltd.), the ultrasonic wave dispersing machine, the mechanical homogenizer, Manton Gaulin, or the pressure-type homogenizer. It should be noted that the mass average primary particle diameter of resin particles is a resin particle diameter measured by using an electrophoretic light scattering spectrophotometer “ELS-800” (available from Otsuka Electronics Co., Ltd.) The liquid dispersion of the colorant particles used in the salting-out/fusing step can be prepared by dispersing the colorant in a water-base medium. The colorant-dispersing process is carried out in the water in a state where the concentration of the surfactant has been made equal to or higher than the critical micelle concentration (CMC).

Although the dispersing machine used in the colorant-dispersing process is not particularly limited, it is preferable to employ a dispersing machine which generates a shearing force by a screen defining a stirring chamber, and a rotor rotating in the stirring chamber at a high speed, and finely disperses the colorant in the water-base medium containing the surfactant by action of the shearing force (further, by action of collision force, changes in pressure, cavitation, and potential core), thereby forming fine particles. Examples of such a machine include pressure dispersing machines, such as the mechanical dispersing apparatus “CLEARMIX” (available from M Technique Co., Ltd.), the ultrasonic wave dispersing machine, the mechanical homogenizer, Manton Gaulin, and the pressure-type homogenizer, and medium-type dispersing machines, such as a sand grinder, Getzmann Mill, and Diamond Fine Mill. Further, the same surfactant as enumerated above can be used in the salting-out/fusing step.

The colorant particles have a mass average particle diameter (dispersed particle diameter) of 30 to 500 nm, preferably 50 to 300 nm.

When the mass average particle diameter of the fine particles of the colorant is smaller than 30 nm, the floating of colorant particles in the water-base medium is increased, and when the mass average particle diameter exceeds 500 nm, the colorant particles are not properly dispersed in the water-base medium and made liable to settle out, so that it is sometimes difficult to introduce the colorant into the toner particles. Under such conditions, the colorant particles unfavorably remain free in the water-base medium without being taken into the toner particles. It should be noted that the mass average particle diameter of the fine particles of the colorant is measured by using the electrophoretic light scattering spectrophotometer “ELS-800” (available from Otsuka Electronics Co., Ltd.).

In the salting-out/fusing step, a salting-out agent comprised of a metal salt is added to a water-base medium in which resin particles and colorant particles are present, as an aggregating agent to a concentration not lower than a critical aggregation concentration, and then the water-base medium is heated to a temperature equal to or higher than a glass transition temperature of the resin particles, whereby salting out and fusing of the resin particles and the colorant particles are caused to proceed at the same time. In this step, an organic solvent that is infinitely soluble in water may be added.

Examples of the aggregating agent include metal salts formed from alkali metals (monovalent metals), such as sodium, potassium, and lithium, metal salts formed from alkaline earth, such as calcium and magnesium, and bivalent metals, such as manganese and copper, and metal salts formed from trivalent metals, such as iron and aluminum, but it is preferable to use the metal salts formed from the bivalent or trivalent metals, since the metal salts formed from the bivalent and trivalent metals have a smaller critical aggregation concentration (coagulation value, coagulation point) than that of the metal salts formed from the monovalent metals.

The above metal salts can be used alone or in combination of two or more.

Examples of the aggregating agent include sodium chloride, potassium chloride, lithium chloride, calcium chloride, zinc chloride, copper sulfate, magnesium sulfate, manganese sulfate, aluminum chloride, and iron chloride.

Although the aggregating agent is only required to be added such that the concentration of the aggregating agent is not lower than the critical aggregation concentration, the aggregating agent is preferably added such that the concentration of the aggregating agent becomes equal to or higher than 1.2 times the critical aggregation concentration, more preferably 1.5 times the critical aggregation concentration.

It is arbitrarily selected whether the metal salt is added to the water-base medium in which the resin particles and the colorant particles are present, directly or in the form of aqueous solution thereof, but when the metal salt is added in the form of the aqueous solution thereof, it is necessary that the concentration of the added metal salt is equal to or higher than the critical aggregation concentration, with respect to a total volume of the water-base medium and the aqueous solution of the metal salt.

The term “critical aggregation concentration” is intended to mean an index concerning stability of an aqueous dispersed material, that is, the concentration of the aggregating agent at which aggregation due to addition of the aggregating agent occurs.

The critical aggregation concentration is largely changed depending on an emulsified component and a dispersant itself. For example, it is possible to accurately determine a critical aggregation concentration by a method described e.g. in Seizo Okamura, et. al “Polymer Chemistry” (17, 601 (1960): compiled by the Society of Polymer Science, Japan. Further, another method can be employed in which a desired kind of salt is added to a liquid dispersion of target particles while changing a resultant salt concentration of the dispersion, and ξ electric potential of the dispersion is measured, whereby it is possible to determine a salt concentration at which the value of the ξ electric potential is changed, as the critical aggregation concentration.

Examples of the above organic solvent which is infinitely soluble in water include methanol, ethanol, 1-propanol, 2-propanol, ethylene glycol, glycerin, and acetone, but alcohols having 3 or less carbon atoms, such as methanol, ethanol, 1-propanol, and 2-propanol are preferable, and 2-propanol is particularly preferable.

In the salting-out/fusing step, assuming that the glass transition temperature of a resin as the material of the resin particles is represented by Tg, the temperature suitable for the salting-out/fusing process is in a range of (Tg+10° C.) to (Tg+50° C.), particularly preferably in a range of (Tg+15° C.) to (Tg+40° C.). It should be noted that the fusion can be effectively conducted by adding the organic solvent which is infinitely soluble in water, to the system processed in the salting-out/fusing step.

Further, in the salting-out/fusing step, it is important to continue the salting-out/fusing process by holding the temperature of the liquid dispersion of the resin particles and the colorant particles for a predetermined time period, after the temperature of the dispersion has reached a temperature equal to or higher than the glass transition temperature. This makes it possible to effectively cause the growth of the toner particles (aggregation of resin particles and colorant particles), and the fusion thereof (extinction of interfaces between the particles) to proceed, thereby making it possible to enhance durability of a toner as a final product.

Further, it is preferable to carry out aging treatment by continuing the fusion by heating the dispersion, after stopping the growth of associated particles.

The aging treatment is a process in which the temperature of a system in which the growth of associated particles has been stopped is held in the vicinity of a melting point Tm of the release agent, preferably at a temperature in a range of Tm to (Tm+30° C.), to thereby continue stirring with a predetermined intensity. By carrying out the aging treatment, the shapes of the toner particles constituting the toner can be made uniform.

(5) Filtering/Washing Step

In the filtering/washing step, there are carried out a filtering process for separating the toner particles from the liquid dispersion thereof obtained through the above steps, by filtration, and a washing process in which attached substances, such as the surfactant and the salting-out agent are removed from the toner particles (cake-like aggregate) separated from the dispersion by filtration.

The method of the filtration includes, for example, a centrifugation method, a vacuum filtering method carried out using a nutsche or the like, and a filtering method carried out using a filter press or the like, but not particularly limited thereto.

(6) Drying Step

This step is carried out to dry the toner particles washed in the washing step.

Examples of the drier used in the drying step include flash jet driers, spray driers, vacuum freeze driers, and vacuum driers, and it is preferable to use standing tray dryers, movable tray dryers, fluidized-bed layer dryers, rotary dryers, stirring dryers, and the like.

The moisture content of the dried toner particle is preferably 5 mass % or less, more preferably 2 mass % or less.

Further, when the dried toner particles are aggregated to each other by a weak interparticle attracting force, the aggregate may be crushed. As a crushing machine, it is possible to use a mechanical crushing apparatus, such as a jet mill, the Henschel mixer, a coffee mill, and a food processor.

(7) External Additive-Adding Step

This step is for adding an external additive to the dried toner particles.

The toner according to the present invention may be additionally comprised of not only the colorants and the release agent but also materials capable of imparting various capabilities to the toner. One example of such a material is a charge-controlling agent. Such materials can be added by various methods including a method in which the material(s) is/are added together with the resin particles and the colorant particles in the fusing step, so as to cause them to be contained in the toner, and a method of adding the material(s) to the resin particles themselves.

Similarly, it is possible to use various types of known charge-controlling agents which can be dispersed in water. Examples of the charge-controlling agents include nigrosine dye, metal salts of naphthenic acid or higher fatty acids, alkoxylated amines, quaternary ammonium salt compounds, azo metal complexes, metal salts of salicylic acid and metal complexes thereof.

The toner according to the present invention is a so-called associated-type toner obtained by carrying out the step of salting-out and fusing resin particles and colorant particles in a water-base medium, and since the toner has a ratio related to specific magnitudes of adhesive stress, it has adhesiveness between the toner particles reduced in temperature dependency, which enables the toner to have an excellent image formability derived from stable fluidity and electrostatic chargeability. As a result, by utilizing the frictional charge effect by the toner carrier and the toner layer limiting member, a necessary amount of charge can be imparted to the toner without yielding any image defect, such as hollowing of an image obtained, and fogging. This enables high-quality images to be obtained for a long time period.

Therefore, according to the toner of the present invention, it is possible to stably obtain high-quality images by the non-magnetic single component development system.

The above advantageous effects are marked when the toner has fine particles having a particle diameter of 9 μm or less, and the heat capacity thereof is small.

A preferable example of the associated-type toner having a ratio related to specific magnitudes of adhesive stress is formed such that the arithmetic average value of shape factors of toner particles thereof is 1.0 to 1.5; a coefficient of variation of shape factor is 16% or less; the ratio of rounded toner particles is 50 number % or more; the ratio of toner particles having a volume average particle diameter of 2.5 μm is 10 volume % or less; a small-sized external additive and a large-sized external additive are added; the above external additives are mixed by a multi-step mixing method in which the small-sized external additive and the large-sized external additive are added in the mentioned order, and mixed. This toner satisfies all the predetermined features of the toner according to the invention.

The toner described hereinbefore can be suitably used as a non-magnetic single component developer, and particularly as a toner for forming color images.

According to the image forming method using the non-magnetic single component developer, an electrostatic latent image formed on a surface of an electrostatic latent image carrier is developed by the non-magnetic single component development system using a toner carried and transferred by a toner carrier with which a toner layer limiting member for limiting the amount of the toner on the surface of the toner carrier has been brought into pressure contact, then the toner forming a toner image which is visualized by the development on the surface of the electrostatic latent image carrier, is transferred to an image support (hereinafter referred to as the “recording member”), such as paper, and the transferred toner is thermally fixed, whereby a visible image is formed on the recording member.

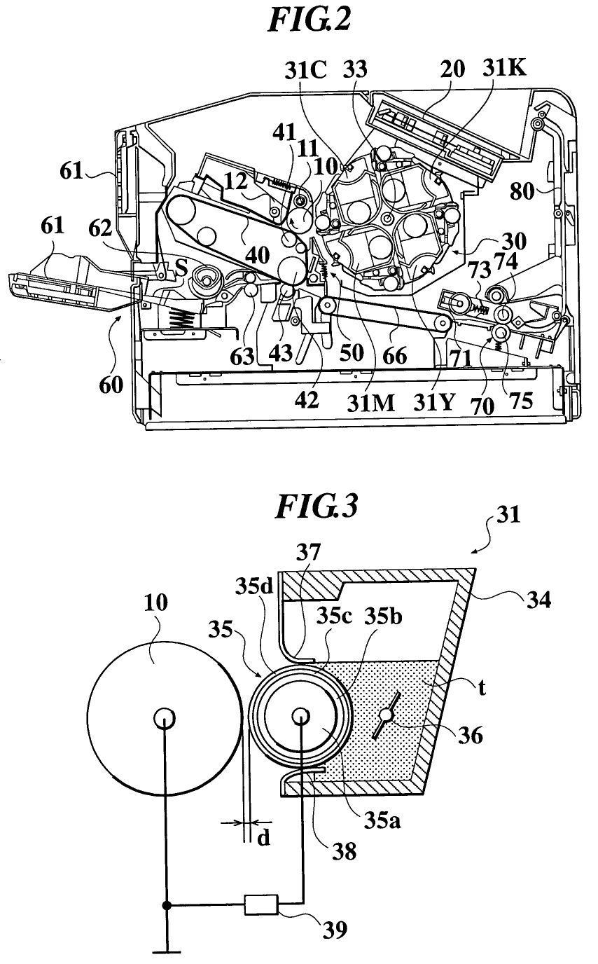

FIG. 2 is a diagram schematically showing an example of the arrangement of an image forming apparatus used in the present invention.

The image forming apparatus is comprised of an electrostatic latent image carrier (hereinafter simply referred to as “the image carrier”) 10 formed by a photoreceptor drum rotating clockwise as viewed in FIG. 2 (in a direction indicated by an arrow in FIG. 2), a charging brush 11 for uniformly charging a surface of the image carrier 10 to a predetermined potential, an optical laser scanning system 20 which contains, for example, a laser diode, a polygon mirror, and an fθ optical element, and executes scanning exposure by a laser beam to thereby form an electrostatic latent image on the surface of the image carrier 10 based on image information of an image to be formed on the image carrier 10 uniformly charged, a developing device 30 for developing the electrostatic latent image formed on the surface of the image carrier 10 to thereby form a toner image, an endless intermediate transfer belt 40 to which the toner image formed on the image carrier 10 is primarily transferred by urging operation of a primary transfer roller 41, a secondary transfer roller 43 for transferring the primary transfer toner image primarily transferred on the intermediate transfer belt 40 onto a recording member S, such as paper, by urging operation thereof, at a portion of the intermediate transfer belt 40, supported by a support roller 42, and a fixing device 70 that includes a heating roller 71 formed by a tension roller provided with a halogen heater, a fixation belt 73 stretched around a fixation roller 74 formed by a drive roller, and a pressure roller 75 brought into pressure contact with the fixation roller 74 via the fixation belt 73, and fixes the toner image transferred on the surface of the recording member S.

In FIG. 2, reference numeral 12 designates cleaning means for scraping off toner remaining on the image carrier 10, reference numeral 50 designates cleaning means for scraping off toner remaining on the intermediate transfer belt 40, reference numeral 60 designates paper supply means for guiding the recording member S to the intermediate transfer belt 40, reference numeral 66 designates feeding means for feeding the recording member S having a secondary transfer toner image formed thereon to the fixing device 70, and reference numeral 80 designates an perpendicular feeding passage for feeding a recording member S having a toner image fixed thereon to an exit.

The paper supply means 60 comprises a paper supply tray 61 for containing recording members S therein, a paper supply roller 62 for supplying the recording members S contained in the paper supply tray 61 one by one, and a timing roller 63 for feeding each recording member S supplied in synchronism with formation of a primary transfer toner image on the intermediate transfer belt 40, between the intermediate transfer belt 40 and the secondary transfer roller 43.

The developing device 30 is a full color developing device for supplying respective toners (non-magnetic single component developers) of cyan, magenta, yellow, and black to the image carrier 10 having an electrostatic latent image formed thereon to thereby carry out full color development. The developing device 30 has four color-specific developing units 31C (for cyan), 31M (for magenta), 31Y (for yellow), and 31K (for black), arranged around a support shaft 33, for holding respective toners of the four colors, and is configured such that the developing units 31C, 31M, 31Y, 31K are rotated about the support shaft 33, for being guided to respective positions opposed to the image carrier 10.

Hereinafter, the developing units 31C, 31M, 31Y, 31K forming the developing device 30 will be described with reference to FIG. 3. The developing units 31C, 31M, 31Y, 31K are constructed similarly to each other.

FIG. 3 is an explanatory cross-sectional view useful for explaining the arrangement of each developing unit of the developing device 30 of the FIG. 2 image forming apparatus. In FIG. 3, the developing unit is shown in a simplified manner.

The developing unit 31 includes a developing unit body 34 for accommodating components of the developing device 30 and a toner t, a toner carrier 35 arranged in a manner opposed to the image carrier 10 with a predetermined distance d therefrom, a feed member 36 for supplying toner to the toner carrier 35, a toner layer limiting member (hereinafter simply referred to as “the limiting member”) 37 that limits the amount of toner transferred and carried on a surface of the toner carrier 35, and at the same time acts to cause frictional charge on the toner transferred and carried on the toner carrier 35, a static eliminator 38 for eliminating static electricity from toner remaining on the surface of the toner carrier 35 after development, and a development bias power supply 39.

In the developing unit 31, when the toner carrier 35 rotates, the toner contained in the developing unit body 34 is supplied to the toner carrier 35 by the feed member 36, and the limiting member 37 is brought into pressure contact with the surface of the toner carrier 35 in this state, whereby the amount of toner transferred and carried on the surface of the toner carrier 35 is limited, and at the same time the toner is charged by friction.

Then, when the toner, which is carried on the surface of the toner carrier 35 bearing a required amount of electric charge generated by the frictional charge, is guided to a developing area opposed to the image carrier 10 with the predetermined distance d therefrom, the toner carried on the surface of the toner carrier 35 is caused to fly between the toner carrier 35 and the image carrier 10 by action of an alternating electric field generated between the toner carrier 35 and the image carrier 10 when an alternating voltage is applied by the development bias power supply 39, and an electrostatic latent image formed on the image carrier 10 is developed by the toner.

Further, when the toner is brought into contact with the static eliminator 38, static electricity is eliminated from the toner remaining on the surface of the toner carrier 35 after development, whereby the toner is separated from the surface of the toner carrier 35, and returned to the inside of the developing unit body 34.

It is preferable to use a toner carrier 35 whose surface has an arithmetic mean roughness Ra of 0.8 to 2.5 μm, and at the same time a ten-point average roughness Rz of 0.5 to 15.0.

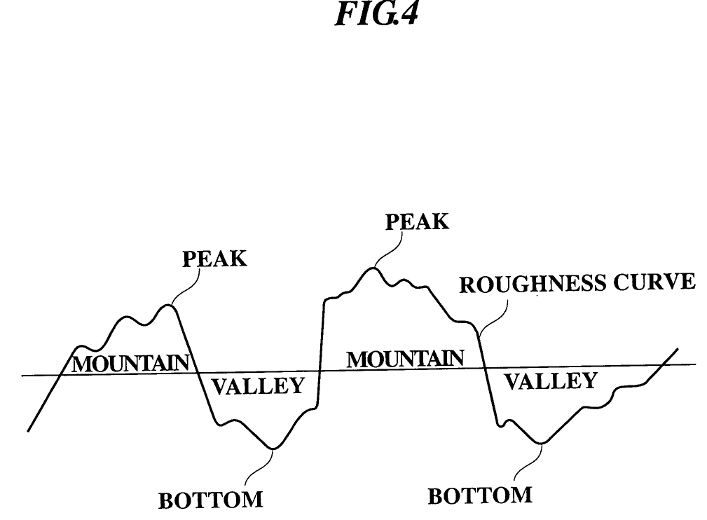

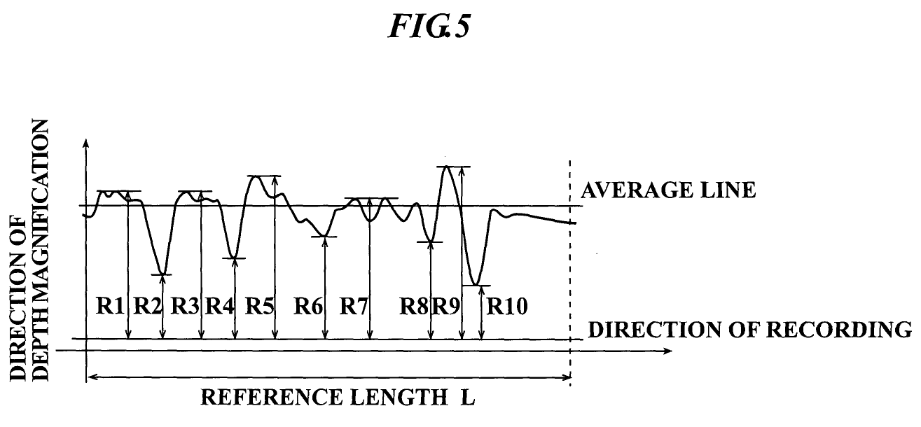

Now, the term “ten-point average roughness Rz” is intended to mean an average roughness measured by the method defined in JIS-B0601-1982, and calculated by Equation (4) shown below: Referring to FIG. 4 and FIG. 5, the ten-point average roughness Rz represents, with respect to a portion of the roughness curve over a reference length, an average altitude difference in μm between an average value of altitudes of the highest peak to the fifth highest peak measured from a straight line parallel to an average line and at the same time not crossing the roughness curve, in a direction of depth magnification, and an average value of altitudes of the deepest bottom to the fifth deepest bottom measured from the straight line in the same direction.

Now, the term “roughness curve” is intended to mean a curve indicative of a contour of cross-section of a portion of the toner carrier obtained by cutting off a surface undulation component longer than a wavelength of 0.8 mm from the curve (contour appearing in an cut when a material to be measured is cut off) having the reference length. The term “reference length” represents a predetermined length of the portion of the toner carrier from which the curve indicative of the contour of the cross-section of the toner carrier is taken out. In the present invention, the reference length is set to 2 mm. The term “average line” represents a curved line of a surface to be measured of the portion taken out as the roughness curve, and at the same time set such that the sum of squares of differences between the line and the roughness curve is minimized. The term “peak” represents a portion of a mountain of the roughness curve, having a highest altitude. The term “bottom” represents a portion of a valley of the roughness curve, having a lowest altitude.

Rz=(R1+R3+R5+R7+R9)−(R2+R4+R6+R8+R10)/5 (4)

where L is a reference length (2 mm), R1+R3+R5+R7+R9 is the altitudes of the highest peak to the fifth highest peak in a taken out portion corresponding to the reference length L, and R2+R4+R6+R8+R10 is the altitudes of the deepest bottom to the fifth deepest bottom in a taken out portion corresponding to the reference length L.

To adjust the ten-point average roughness Rz to a predetermined range, there may be employed a method of adding a filler for controlling the magnitude of Rz e.g. to a coating liquid, referred to hereinafter, to be coated on a surface layer. Inorganic fine particles e.g. of titanium oxide or silica, and fine resin particles e.g. of polymethyl methacrylate or nylon can be used as fillers. The ten-point average roughness Rz on the surface of the toner carrier can be variously controlled depending on the size of the filler. Further, to increase the ten-point average roughness Rz, a method of increasing the amount of filler added may be employed.

When the arithmetic mean roughness Ra on the toner carrier 35 exceeds 0.8 μm, the amount of toner taken in by the toner carrier 35 is large, which reduces electrostatic chargeability in a limiting section for limiting the amount of toner, using the toner layer limiting member, so that there is a fear of fogging being caused due to defective charge. On the other hand, when the arithmetic mean roughness Ra on the surface of the toner carrier 35 is smaller than 2.5 μm, the amount of toner taken in by the toner carrier 35 is small, so that there is a fear of unevenness of an image and faulty following operation being liable to occur.

When the ten-point average roughness Rz on the toner carrier 35 is smaller than 5.0, latitude in image leakage and unevenness of density in the developing step can be narrowed, whereas when the ten-point average roughness Rz in the toner carrier 35 exceeds 15.0, the latitude in image leakage and unevenness of density in the developing step are widened, but this necessitates increase in the capacity of high voltage power supply, which can result in an increase in manufacturing costs of the toner.

Further, the toner carrier 35 is configured such that an elastic layer 35b, an intermediate layer 35c, and a surface layer 35d are laminated in the mentioned order on a surface of a conductive substrate 35a formed by a metal roller. It is preferable that a volume resistivity σ1 of the elastic layer 35b, a volume resistivity σ2 of the intermediate layer 35c, and a volume resistivity σ3 of the surface layer 35d satisfy a predetermined condition of σ2≦σ1≦σ3.

When the volume resistivities of the elastic layer 35b, the intermediate layer 35c, and the surface layer 35d constituting the toner carrier 35 satisfy the predetermined condition, even if there exists a variation in the volume resistivity σ1 of the elastic layer, the variation is lessened by the intermediate layer 35c having a smaller volume resistivity than the volume resistivity σ1, and further due to provision of the surface layer 35d having a larger volume resistivity than the volume resistivity σ1, the toner carrier 35 comes to have a proper volume resistivity as a whole. This makes it possible to suppress generation of unevenness in the alternating electric field acting between the toner carrier 35 and the image carrier 10.

Further, also even when a small-sized toner having a volume average particle diameter of 9 μm or less is used as a non-magnetic single component developer, it is possible to obtain an excellent image suppressed in generation of unevenness of density.

As the elastic layer 35b, there can be used a layer which is formed by adding fine particles of a conductive agent, such as Ketjen black, acetylene black, furnace black, titanium black, or metal oxides, to an elastic material formed e.g. of silicone rubber, isoprene rubber, butadiene rubber, butyl rubber, chloroprene rubber, nitrile rubber, styrene-butadiene rubber, acrylic rubber, ethylene-propylene rubber, ethylene-propylene-diene rubber, urethane rubber, fluororubber, thermoplastic elastomers, or the like.

Preferably, the elastic layer 35b has a volume resistivity σ1 of 1×10⁴ to 1×10⁶ Ω·m.

When the volume resistivity σ1 is less than 1×10⁴ Ω·m, moldability of the elastic layer 35b can be reduced, whereas when the volume resistivity σ1 exceeds 1×10⁶ Ω·m, unevenness of the volume resistivity can be increased in the elastic layer.

Further, the elastic layer 35b has a thickness of 0.3 to 1.5 mm, preferably 0.5 to 1.0 mm, and a hardness of 5 to 60 degrees, preferably 10 to 50 degrees according to the JIS-A hardness.

As the intermediate layer 35c, there can be used a layer which is formed by adding any of the same conductive agents as used in forming the elastic layer 35b, e.g. to silicone rubber, isoprene rubber, butadiene rubber, butyl rubber, chloroprene rubber, nitrile rubber, styrene butadiene rubber, acrylic rubber, ethylene-propylene rubber, urethane rubber, epichlorohydrin rubber, silicone resin, acrylic resin, polyester resin, ABS resin, styrene resin, urethane resin, or the like.

It is preferable that the intermediate layer 35c has a volume resistivity σ2 of 1×10⁴ Ω·m or less. If the volume resistivity σ2 of the intermediate layer 35c is within this range, it is possible to adjust the volume resistivity σ1 of the elastic layer 35b to the predetermined range.

The intermediate layer 35c has a thickness of 5 to 30 μm, preferably 10 to 25 μm.

As the surface layer 35d, there can be used a layer which is formed by adding any of the same conductive agents as used in forming the elastic layer 35b, e.g. to silicone rubber, butadiene rubber, chloroprene rubber, nitrile rubber, acrylic rubber, urethane rubber, silicone resin, acrylic resin, urethane resin, fluorocarbon resin, nylon resin, or the like.

Preferably, the surface layer 35d has a volume resistivity σ3 of 1×10⁶ to 1×10¹² Ω·M.

When the volume resistivity σ3 is less than 1×10⁶ Ω·m, leakage is liable to occur when the alternating electric field is caused to act between the toner carrier 35 and the image carrier 10 so as to perform development, whereas when the volume resistivity σ3 exceeds 1×10¹² Ω·m, the alternating electric field caused to act between the toner carrier 35 and the image carrier 10 is reduced in strength, which can make it impossible to supply sufficient toner to an image portion of the image carrier 10.

Further, the surface layer 35d has a thickness of 5 to 40 μm, preferably 10 to 30 μm.

The toner carrier 35 constructed as above can be formed, for example, by setting the conductive substrate 35a in an elastic layer forming mold, injecting an elastic layer coating liquid around the periphery of the conductive substrate 35a in the mold and curing the liquid, removing the mold to form an elastic layer 35b on the peripheral surface of the conductive substrate 35a, coating an intermediate layer coating liquid on a surface of the formed elastic layer 35b and drying the liquid to form an intermediate layer 35c, and further coating a surface layer coating liquid on a surface of the formed intermediate layer 35c and drying the liquid to form a surface layer 35d. Thus, it is possible to produce the toner carrier 35 having the elastic layer 35b, the intermediate layer 35c, and the surface layer 35d laminated in the mentioned order on the surface of the conductive substrate 35a.

### EXAMPLE

Now, Examples of the present invention will be described. Of course, the present invention is not limited to these Examples.

It should be noted that in the following, “parts” means “parts by mass”.

### Preparation Example 1 of Resin Particles

In a flask equipped with a stirring device, 72.0 g of a compound represented by the above formula (W19) (hereinafter referred to as “Exemplified compound (W19)”) was added to a monomer mixture solution consisting of 115.1 g of styrene, 42.0 g of n-butyl acrylate, and 10.9 g of methacrylic acid, and the resulting mixture was heated to 80° C. to dissolve the Exemplified compound to thereby prepare a monomer solution.

On the other hand, a separable flask having a capacity of 5000 ml and equipped with a stirring device, a temperature sensor, a cooling pipe, and a nitrogen-introducing device was charged with a surfactant solution (water-base medium) obtained by dissolving 7.08 g of anionic surfactant (sodium dodecylbenzene sulfonate: SDS) in 2760 g of deionized water, and the internal temperature was raised to 80° C., with stirring at a stirring speed of 230 rpm under a nitrogen gas stream.

Then, the monomer solution (80° C.) was mixed and dispersed in the surfactant solution (80° C.) by using a mechanical dispersing apparatus “CLEARMIX” (available from M Technique Co., Ltd.) having a circulation path, whereby an emulsion (dispersion) containing emulsified articles (oil droplets) dispersed with a uniform dispersed particle diameter was prepared.

After that, an initiator solution prepared by dissolving 0.84 g of polymerization initiator (potassium persulfate: KPS) in 200 g of deionized water was added to the dispersion, and the system was heated with stirring at 80° C. for three hours, whereby polymerization reaction was conducted. A solution prepared by dissolving 7.73 g of polymerization initiator (KPS) in 240 ml of deionized water was added to the obtained reaction solution, and after 15 minutes, when the temperature was 80° C., a mixture consisting of 383.6 g of styrene, 140.0 g of n-butyl acrylate, 36.4 g of methacrylic acid, and 12 g of n-octyl melcaptan was dropwise added over 100 minutes. The resulting system was heated with stirring at 80° C. for 60 minutes, and then cooled down to 40° C., whereby a dispersion (hereinafter also referred to as “Latex (1)”) of resin particles containing Exemplified compound (W19) was prepared.

### Preparation Example 1 of Colorant Dispersion

9.2 g of sodium n-dodecyl sulfate was dissolved in 160 ml of deionized water, with stirring. While stirring the solution, 20 g of carbon black “Mogul L” (available from Cabot Corporation) was gradually added to the solution as a colorant, and then dispersed using the mechanical dispersing apparatus “CLEARMIX” (available from M Technique Co., Ltd.), whereby a liquid dispersion of colorant particles (hereinafter referred to as “the colorant dispersion (1)”) was prepared.

A particle diameter of the colorant particles in the obtained colorant dispersion (1) was measured using the electrophoretic light scattering spectrophotometer “ELS-800” (available from Otsuka Electronics Co., Ltd.). The measured particle diameter was 120 nm in weight average particle diameter.

### Preparation Example 2 of Colorant Dispersion

A dispersion of colorant particles (hereinafter referred to as “the colorant dispersion (2)”) was prepared in the same manner as in Preparation Example 1 except that 20 g of pigment “C.I. pigment yellow 74” was used in place of 20 g of carbon black.

A particle diameter of the colorant particles in the obtained colorant dispersion (2) was measured using the electrophoretic light scattering spectrophotometer “ELS-800” (available from Otsuka Electronics Co., Ltd.). The measured particle diameter was 120 nm in weight average particle diameter.

### Preparation Example 3 of Colorant Dispersion

A dispersion of colorant particles (hereinafter referred to as “the colorant dispersion (3)”) was prepared in the same manner as in Preparation Example 1 except that 20 g of quinacridone magenta pigment “C.I. pigment red 122” was used in place of 20 g of carbon black.

A particle diameter of the colorant particles in the obtained colorant dispersion (3) was measured using the electrophoretic light scattering spectrophotometer “ELS-800” (available from Otsuka Electronics Co., Ltd.). The measured particle diameter was 120 nm in weight average particle diameter.

### Preparation Example 4 of Colorant Dispersion

A dispersion of colorant particles (hereinafter referred to as “the colorant dispersion (4)”) was prepared in the same manner as in Preparation Example 1 except that 20 g of phthalocyanine cyan pigment “C.I. pigment blue 15:3” was used in place of 20 g of carbon black.

A particle diameter of the colorant particles in the obtained colorant dispersion (4) was measured using the electrophoretic light scattering spectrophotometer “ELS-800” (available from Otsuka Electronics Co., Ltd.). The measured particle diameter was 120 nm in weight average particle diameter.

### Preparation Example K1 of Colorant Particles

A reaction vessel (four-neck flack) having a capacity of 5 liters and equipped with a temperature sensor, a cooling pipe, a nitrogen-introducing device, a stirring device (having two stirring blades with a crossing angle of 20 degrees), and a shape-monitoring device was charged with 1250 g of the Latex (1) (in terms of solid content), 2000 ml of deionized water, and a whole amount of the colorant dispersion (1). After the internal temperature was adjusted to 25° C., 5 mol/liter of sodium hydroxide solution was added to the dispersion mixture to adjust the pH to 10.0. Then, to the resulting liquid dispersion mixture, a solution prepared by dissolving 52.6 g of magnesium chloride hexahydrate in 72 ml of deionized water was added with stirring at 25° C. over 10 minutes. The mixture was allowed to stand for 3 minutes, and the temperature of the system started to be raised up to 95° C. over 5 minutes (temperature-raising speed of 14° C./min).

In the above state, particle diameters of associated particles were measured using the “Coulter Counter TA-II”, and when the volume average particle diameter reached 6.5 μm, a solution prepared by dissolving 115 g of sodium chloride in 700 ml of deionized water was added to stop the growth of the particles. Further, the fusing of particles was continued by heating at a liquid temperature of 90° C. for 8 hours with stirring (stirring rotation rate of 120 rpm), whereby the aging treatment was conducted. Subsequently, the system was cooled down to 30° C. at a cooling speed of 10° C./min, and hydrochloric acid was added to adjust the pH to 3.0, followed by stopping the stirring operation.

The produced particles were filtered, repeatedly washed by deionized water, subjected to classification in liquid by a centrifugal machine, and thereafter dried using a flash jet drier, whereby colorant particles (hereinafter referred to as “the colorant particles (K1)”) with a moisture content of 1.0% were obtained.

Characteristics of the obtained colorant particles (K1) were checked. The results of the check are shown in Table 2 and Table 3.

### Preparation Examples K2 to K4 of Colorant Particles

Colorant particles (hereinafter also referred to as “the colorant particles (K2) to (K4)”) were obtained in the same manner as in Preparation Example K1 except that growth of particles was stopped when the volume average particle diameter became equal to a corresponding size shown in Table 2, and the stirring rotation rate, liquid temperature, and heating-with-stirring time period for the aging treatment were set to conditions shown in Table 1.

Characteristics of the obtained colorant particles (K2) to (K4) were checked. The results of the check are shown in Table 2 and Table 3.

### Preparation Examples Y1 to Y4 of Colorant Particles

Colorant particles (hereinafter also referred to as “the colorant particles (Y1) to (Y4)”) were obtained in the same manner as in Preparation Example K1 except that a whole amount of the colorant dispersion (2) was used in place of the whole amount of the colorant dispersion (1), the growth of particles was stopped when the volume average particle diameter thereof became equal to a corresponding size shown in Table 2, and the stirring rotation rate, liquid temperature, and heating-with-stirring time period for the aging treatment were set to conditions shown in Table 1.

Characteristics of the obtained colorant particles (Y1) to (Y4) were checked. The results of the check are shown in Table 2 and Table 3.

### Preparation Examples M1 to M4 of Colorant Particles

Colorant particles (hereinafter also referred to as “the colorant particles (M1) to (M4)”) were obtained in the same manner as in Preparation Example K1 except that a whole amount of the colorant dispersion (3) was used in place of the whole amount of the colorant dispersion (1), the growth of particles was stopped when the volume average particle diameter thereof became equal to a corresponding size shown in Table 2, and the stirring rotation rate, liquid temperature, and heating-with-stirring time period for the aging treatment were set to conditions shown in Table 1.

Characteristics of the obtained colorant particles (M1) to (M4) were checked. The results of the check are shown in Table 2 and Table 3.

### Preparation Examples C1 to C4 of Colorant Particles

Colorant particles (hereinafter also referred to as “the colorant particles (C1) to (C4)”) were obtained in the same manner as in Preparation Example K1 except that a whole amount of the colorant dispersion (4) was used in place of the whole amount of the colorant dispersion (1), the growth of particles was stopped when the volume average particle diameter thereof became equal to a corresponding size shown in Table 2, and the stirring rotation rate, liquid temperature, and heating-with-stirring time period for the aging treatment were set to conditions shown in Table 1.

Characteristics of the obtained colorant particles (C1) to (C4) were checked. The results of the check are shown in Table 2 and Table 3.

TABLE 1

| | STIRRING | | STIRRING |
|---|---|---|---|
| | ROTATION | LIQUID | TIME UNDER |
| | RATE | TEMPERATURE | HEATING |
| | (rpm) | (° C.) | (h) |
| COLORANT | 120 | 90 | 8 |
| PARTICLE K1 | | | |
| COLORANT | 140 | 90 | 8 |
| PARTICLE K2 | | | |
| COLORANT | 150 | 88 | 6 |
| PARTICLE K3 | | | |
| COLORANT | 120 | 95 | 10 |
| PARTICLE K4 | | | |
| COLORANT | 120 | 90 | 8 |
| PARTICLE Y1 | | | |
| COLORANT | 140 | 90 | 8 |
| PARTICLE Y2 | | | |
| COLORANT | 150 | 88 | 6 |
| PARTICLE Y3 | | | |
| COLORANT | 120 | 95 | 10 |
| PARTICLE Y4 | | | |
| COLORANT | 120 | 90 | 8 |
| PARTICLE M1 | | | |
| COLORANT | 140 | 90 | 8 |
| PARTICLE M2 | | | |
| COLORANT | 150 | 88 | 6 |
| PARTICLE M3 | | | |
| COLORANT | 120 | 95 | 10 |
| PARTICLE M4 | | | |
| COLORANT | 120 | 90 | 8 |
| PARTICLE C1 | | | |
| COLORANT | 140 | 90 | 8 |
| PARTICLE C2 | | | |
| COLORANT | 150 | 88 | 6 |
| PARTICLE C3 | | | |
| COLORANT | 120 | 95 | 10 |
| PARTICLE C4 | | | |

### Preparation Example K5 of Colorant Particles: Preparation Example of Comparative Colorant Particles

Raw materials of a toner consisting of 100 kg of styrene-n-butylacrylate copolymer resin, 10 kg of carbon black “Mogul L” (available from Cabot Corporation), and 4 kg of polypropylene were preliminarily mixed by the Henschel mixer, and then melt-kneaded by a twin-screw extruder. The melt-kneaded mixture was roughly pulverized by a hammer mill, and pulverized by a jet pulverizing machine. The obtained powder was repeatedly subjected to classification using a wind classifier until the powder in target particle diameter distribution was produced. Thus, colorant particles (hereinafter referred to as “the colorant particles (K5)”) having a volume average particle diameter shown in Table 2 were obtained.

### Preparation Example Y5 of Colorant Particles: Preparation Example of Comparative Colorant Particles

Colorant particles (hereinafter referred to as “the colorant particles (Y5)”) having a volume average particle diameter shown in Table 2 was obtained in the same manner as in Preparation Example K5 except that 10 kg of pigment “C.I. pigment yellow 74” was used in place of 10 kg of carbon black.

### Preparation Example M5 of Colorant Particles: Preparation Example of Comparative Colorant Particles

Colorant particles (hereinafter referred to as “the colorant particles (M5)”) having a volume average particle diameter shown in Table 2 ware obtained in the same manner as in Preparation Example K5 except that 10 g of quinacridone magenta pigment “C.I. pigment red 122” was used in place of 10 kg of carbon black.

### Preparation Example C5 of Colorant Particles: Preparation Example of Comparative Colorant Particles

Colorant particles (hereinafter referred to as “the colorant particles (C5)”) having a volume average particle diameter shown in Table 2 were obtained in the same manner as in Preparation Example K5 except that 10 g of phthalocyanine cyan pigment “C.I. pigment blue 15:3” was used in place of 10 kg of carbon black.

TABLE 2

| | | | | RATIO OF | |
|---|---|---|---|---|---|
| | | | | COLORANT | |
| | | | | PARTICLES | |
| | ARITHMETIC | COEFFICIENT OF | RATIO OF | HAVING | VOLUME |
| COLORANT | MEAN VALUE | VARIATION | ROUNDED | PREDETERMINED | AVERAGE |
| PARTICLE | OF SHAPE | OF SHAPE | COLORANT | PARTICLE | PARTICLE |
| NUMBER | FACTOR | FACTOR | PARTICLES | DIAMETER | DIAMETER |
| COLORANT | 1.30 | 9% | 91 NUMBER % | 7.6 VOLUME % | 6.5 μm |
| PARTICLE | | | | | |
| K1 | | | | | |
| COLORANT | 1.40 | 12% | 88 NUMBER % | 6.1 VOLUME % | 6.6 μm |
| PARTICLE | | | | | |
| K2 | | | | | |
| COLORANT | 1.45 | 15% | 83 NUMBER % | 9.1 VOLUME % | 6.6 μm |
| PARTICLE | | | | | |
| K3 | | | | | |
| COLORANT | 1.56 | 17% | 81 NUMBER % | 9.6 VOLUME % | 6.6 μm |
| PARTICLE | | | | | |
| K4 | | | | | |
| COLORANT | 1.65 | 22% | 42 NUMBER % | 11.8 VOLUME % | 6.5 μm |
| PARTICLE | | | | | |
| K5 | | | | | |
| COLORANT | 1.32 | 10% | 92 NUMBER % | 7.6 VOLUME % | 6.5 μm |
| PARTICLE | | | | | |
| Y1 | | | | | |
| COLORANT | 1.40 | 14% | 87 NUMBER % | 6.3 VOLUME % | 6.6 μm |
| PARTICLE | | | | | |
| Y2 | | | | | |
| COLORANT | 1.45 | 15% | 83 NUMBER % | 9.1 VOLUME % | 6.6 μm |
| PARTICLE | | | | | |
| Y3 | | | | | |
| COLORANT | 1.57 | 18% | 80 NUMBER % | 9.7 VOLUME % | 6.6 μm |
| PARTICLE | | | | | |
| Y4 | | | | | |
| COLORANT | 1.64 | 24% | 40 NUMBER % | 11.8 VOLUME % | 6.5 μm |
| PARTICLE | | | | | |
| Y5 | | | | | |
| COLORANT | 1.31 | 9% | 94 NUMBER % | 7.3 VOLUME % | 6.5 μm |
| PARTICLE | | | | | |
| M1 | | | | | |
| COLORANT | 1.42 | 13% | 88 NUMBER % | 6.1 VOLUME % | 6.6 μm |
| PARTICLE | | | | | |
| M2 | | | | | |
| COLORANT | 1.45 | 15% | 83 NUMBER % | 9.1 VOLUME % | 6.6 μm |
| PARTICLE | | | | | |
| M3 | | | | | |
| COLORANT | 1.55 | 18% | 80 NUMBER % | 9.7 VOLUME % | 6.6 μm |
| PARTICLE | | | | | |
| M4 | | | | | |
| COLORANT | 1.63 | 23% | 41 NUMBER % | 12.8 VOLUME % | 6.5 μm |
| PARTICLE | | | | | |
| M5 | | | | | |
| COLORANT | 1.31 | 9% | 91 NUMBER % | 7.3 VOLUME % | 6.5 μm |
| PARTICLE | | | | | |
| C1 | | | | | |
| COLORANT | 1.42 | 13% | 82 NUMBER % | 6.5 VOLUME % | 6.6 μm |
| PARTICLE | | | | | |
| C2 | | | | | |
| COLORANT | 1.45 | 15% | 83 NUMBER % | 9.1 VOLUME % | 6.6 μm |
| PARTICLE | | | | | |
| C3 | | | | | |
| COLORANT | 1.58 | 18% | 80 NUMBER % | 9.9 VOLUME % | 6.6 μm |
| PARTICLE | | | | | |
| C4 | | | | | |
| COLORANT | 1.65 | 22% | 42 NUMBER % | 13.8 VOLUME % | 6.5 μm |
| PARTICLE | | | | | |
| C5 | | | | | |

In Table 2, “ratio of rounded colorant particles” indicates a ratio of colorant particles having a volume average particle diameter in a range of 2.5 μm or less.

### Preparation Example 1 of External Additive: Preparation Example of Organic Particles

Redox polymerization initiator (5×10⁻³ mole/l) consisting of potassium persulfate and sodium thiosulfate, as a polymerization initiator, and copper sulfate (2.5×10⁻⁵ mole/l) as an accelerator were added to a system charged with 90 parts by mass of methyl methacrylate, 10 parts by mass of styrene, and 300 parts by mass of distilled water, and the mixture was caused to react at 65° C. for two hours under a nitrogen gas stream. After cooling, the reaction product was subjected to ultrafiltration and dried, whereby resin particles (hereinafter referred to as “the organic particles (1)”) having a number average primary particle diameter of 0.3 μm were obtained.

The glass transition temperature of the organic fine particles (1) measured was 100° C.

### Preparation Example 2 of External Additive: Preparation Example of Composite Fine Particles

17 parts by mass of titanium oxide (average primary particle diameter of 15 nm) subjected to hydrophobic treatment by octyltrimethoxysilane were added as inorganic fine particles to 100 parts by mass of the organic fine particles (1), and the resulting mixture was input to a mixer “OM Dizer” (available from Nara Machinery Co., Ltd.) equipped with a jacket. The organic fine particles and the inorganic fine particles were mixed with stirring at 500 rpm for 3 minutes, while the inside of the mixer was heated by causing water at a temperature of 30° C. to circulate as a medium through the jacket of the mixer, whereby an ordered mixtures was obtained. It should be noted that the article temperature was maintained at 30° C. during the mixing. When the particles in the state of the ordered mixture were observed by the scanning electron microscope, it was confirmed that the inorganic particles were uniformly electrostatically attached to surfaces of the organic particles.

Then, before the obtained ordered mixture was cooled off, the mixture was input to a mixing and stirring machine “Hybridizer” (available from Nara Machinery Co., Ltd.) equipped with a jacket. While heating the inside of the machine by causing water at a temperature of 45° C. to circulate as a medium through the jacket of the machine, a mechanical impact force was applied to the particles in the state of the ordered mixture by mixing the particles with stirring at a peripheral speed of 100 m/sec, for 3 minutes, whereby composite organic fine particles (hereinafter also referred to as “the composite fine articles (1)”) were obtained which had inorganic fine particles stuck to surfaces of the organic fine particles (1) as core fine resin particles. It should be noted that the temperature in the machine was 56° C., during mixing with stirring.

Although inner walls of the machine were observed after termination of the mixing with stirring, no deposited substances were recognized on the inner walls. Further, when the composite fine particles (1) were observed by the scanning electron microscope, mixing of aggregates or lumps of the organic fine particles was not detected. It should be noted that the ration of sticking of the composite fine particles (1) was 86%.

### Preparation Example of Toner

Toner particles were obtained by adding external additives to the colorant particles and comparative colorant particles according to prescriptions shown in Table 3 to Table 6, referred to hereinafter.

It should be noted that the toner particles were not changed in shape or particle diameter by the addition of the external additives.

In Table 3 to Table 6, the term “small particle 1” represents particles of silica subjected to hexamethyldisilazane treatment, and having a number average primary particle diameter of 7 nm, and a degree of hydrophobicity of 62, the term “small particle 2” represents particles of silica subjected to hexamethyldisilazane treatment, and having a number average primary particle diameter of 20 nm, and a degree of hydrophobicity of 66, the term “large particle 1” represents particles of strontium titanate having a number average primary particle diameter of 300 nm, the term “large particle 2” represents the organic fine particles (1), the term “large particle 3” represents the composite fine particles (1), and the term “large particle 4” represents particles of titania subjected to octyltrimethoxysilane treatment, and having a number average primary particle diameter of 100 nm, and a degree of hydrophobicity of 58.

It should be noted that the small particle 1 is a small-sized external additive comprised of inorganic fine particles, the large particle 1 and the large particle 4 are large-sized external additives comprised of inorganic fine particles, the large particle 2 and the large particle 3 are large-sized external additives comprised of organic fine particles. Further, the small particle 2 is an external additive having an average particle diameter larger than that of the small particle 1.

“Method 1” to “Method 4” representing methods of mixing the external additives indicate the following methods, respectively.

“Method 1”: using the Henschel mixer, under the condition of the volume/capacity ratio being equal to 55%, first, after adding a small-sized external additive, a first-stage mixing-with-stirring process is carried out at a stirring speed of 52 m/sec for a stirring time period of 2 minutes, and then, after adding a large-sized external additive, a second-stage mixing-with-stirring process is carried out at a stirring speed of 52 m/sec for a stirring time period of 28 minutes.

“Method 2”: using the Henschel mixer, under the condition of the volume/capacity ratio being equal to 55%, first, after adding a small-sized external additive, a firs-stage mixing-with-stirring process is carried out at a stirring speed of 55 m/sec for a stirring time period of 1 minute, and then, after adding a large-sized external additive, a second-stage mixing-with-stirring process is carried out at a stirring speed of 55 m/sec for a stirring time period of 35 minutes.

“Method 3”: using the Henschel mixer, under the condition of the volume/capacity ratio being equal to 55%, first, after adding a small-sized external additive, a first-stage mixing-with-stirring process is carried out at a stirring speed of 45 m/sec for a stirring time period of 1 minute, and then, after adding a large-sized external additive, a second-stage mixing-with-stirring process is carried out at a stirring speed of 60 m/sec for a stirring time period of 35 minutes.

“Method 4”: using the Henschel mixer, under the condition of the volume/capacity ratio being equal to 55%, after adding a large-sized external additive and a small-sized external additive simultaneously, a mixing-with-stirring process is carried out at a stirring speed of 50 m/sec for a stirring time period of 40 minutes.

TABLE 3

| | TONER | EXTERNAL ADDITIVE | | |
|---|---|---|---|---|
| TONER | PARTICLE | | ADDED | |
| NUMBER | NUMBER | KIND | AMOUNT | METHOD |
| TONER K1 | TONER | SMALL | 1.0 MASS % | METHOD 1 |
| | PARTICLE | PARTICLE 1 | | |
| | K1 | LARGE | 1.0 MASS % | |
| | | PARTICLE 1 | | |
| TONER K2 | TONER | SMALL | 1.0 MASS % | METHOD 2 |
| | PARTICLE | PARTICLE 1 | | |
| | K1 | LARGE | 1.0 MASS % | |
| | | PARTICLE 1 | | |
| TONER K3 | TONER | SMALL | 1.0 MASS % | METHOD 3 |
| | PARTICLE | PARTICLE 1 | | |
| | K1 | LARGE | 1.0 MASS % | |
| | | PARTICLE 1 | | |
| TONER K4 | TONER | SMALL | 1.0 MASS % | METHOD 4 |
| | PARTICLE | PARTICLE 1 | | |
| | K1 | LARGE | 1.0 MASS % | |
| | | PARTICLE 2 | | |
| TONER K5 | TONER | SMALL | 1.0 MASS % | METHOD 4 |
| | PARTICLE | PARTICLE 1 | | |
| | K1 | LARGE | 1.0 MASS % | |
| | | PARTICLE 3 | | |
| TONER K6 | TONER | SMALL | 1.0 MASS % | METHOD 1 |
| | PARTICLE | PARTICLE 1 | | |
| | K1 | SMALL | 0.8 MASS % | |
| | | PARTICLE 2 | | |
| | | LARGE | 1.0 MASS % | |
| | | PARTICLE 1 | | |
| TONER K7 | TONER | SMALL | 1.0 MASS % | METHOD 1 |
| | PARTICLE | PARTICLE 1 | | |
| | K1 | LARGE | 1.0 MASS % | |
| | | PARTICLE 1 | | |
| | | LARGE | 0.8 MASS % | |
| | | PARTICLE 4 | | |
| TONER K8 | TONER | SMALL | 1.0 MASS % | METHOD 1 |
| | PARTICLE | PARTICLE 1 | | |
| | K2 | SMALL | 0.8 MASS % | |
| | | PARTICLE 2 | | |
| | | LARGE | 1.0 MASS % | |
| | | PARTICLE 1 | | |
| TONER K9 | TONER | SMALL | 1.0 MASS % | METHOD 1 |
| | PARTICLE | PARTICLE 1 | | |
| | K3 | SMALL | 0.8 MASS % | |
| | | PARTICLE 2 | | |
| | | LARGE | 1.0 MASS % | |
| | | PARTICLE 1 | | |
| TONER K10 | TONER | SMALL | 1.0 MASS % | METHOD 1 |
| | PARTICLE | PARTICLE 1 | | |
| | K4 | SMALL | 0.8 MASS % | |
| | | PARTICLE 2 | | |
| | | LARGE | 1.0 MASS % | |
| | | PARTICLE 1 | | |
| TONER K11 | TONER | SMALL | 1.0 MASS % | METHOD 1 |
| | PARTICLE | PARTICLE 1 | | |
| | K5 | SMALL | 0.8 MASS % | |
| | | PARTICLE 2 | | |
| | | LARGE | 1.0 MASS % | |
| | | PARTICLE 1 | | |

TABLE 4

| | TONER | EXTERNAL ADDITIVE | | |
|---|---|---|---|---|
| TONER | PARTICLE | | ADDED | |
| NUMBER | NUMBER | KIND | AMOUNT | METHOD |
| TONER Y1 | TONER | SMALL | 1.0 MASS % | METHOD 1 |
| | PARTICLE | PARTICLE 1 | | |
| | Y1 | LARGE | 1.0 MASS % | |
| | | PARTICLE 1 | | |
| TONER Y2 | TONER | SMALL | 1.0 MASS % | METHOD 2 |
| | PARTICLE | PARTICLE 1 | | |
| | Y1 | LARGE | 1.0 MASS % | |
| | | PARTICLE 1 | | |
| TONER Y3 | TONER | SMALL | 1.0 MASS % | METHOD 3 |
| | PARTICLE | PARTICLE 1 | | |
| | Y1 | LARGE | 1.0 MASS % | |
| | | PARTICLE 1 | | |
| TONER Y4 | TONER | SMALL | 1.0 MASS % | METHOD 4 |
| | PARTICLE | PARTICLE 1 | | |
| | Y1 | LARGE | 1.0 MASS % | |
| | | PARTICLE 2 | | |
| TONER Y5 | TONER | SMALL | 1.0 MASS % | METHOD 4 |
| | PARTICLE | PARTICLE 1 | | |
| | Y1 | LARGE | 1.0 MASS % | |
| | | PARTICLE 3 | | |
| TONER Y6 | TONER | SMALL | 1.0 MASS % | METHOD 1 |
| | PARTICLE | PARTICLE 1 | | |
| | Y1 | SMALL | 0.8 MASS % | |
| | | PARTICLE 2 | | |
| | | LARGE | 1.0 MASS % | |
| | | PARTICLE 1 | | |
| TONER Y7 | TONER | SMALL | 1.0 MASS % | METHOD 1 |
| | PARTICLE | PARTICLE 1 | | |
| | Y1 | LARGE | 1.0 MASS % | |
| | | PARTICLE 1 | | |
| | | LARGE | 0.8 MASS % | |
| | | PARTICLE 4 | | |
| TONER Y8 | TONER | SMALL | 1.0 MASS % | METHOD 1 |
| | PARTICLE | PARTICLE 1 | | |
| | Y2 | SMALL | 0.8 MASS % | |
| | | PARTICLE 2 | | |
| | | LARGE | 1.0 MASS % | |
| | | PARTICLE 1 | | |
| TONER Y9 | TONER | SMALL | 1.0 MASS % | METHOD 1 |
| | PARTICLE | PARTICLE 1 | | |
| | Y3 | SMALL | 0.8 MASS % | |
| | | PARTICLE 2 | | |
| | | LARGE | 1.0 MASS % | |
| | | PARTICLE 1 | | |
| TONER Y10 | TONER | SMALL | 1.0 MASS % | METHOD 1 |
| | PARTICLE | PARTICLE 1 | | |
| | Y4 | SMALL | 0.8 MASS % | |
| | | PARTICLE 2 | | |
| | | LARGE | 1.0 MASS % | |
| | | PARTICLE 1 | | |
| TONER Y11 | TONER | SMALL | 1.0 MASS % | METHOD 1 |
| | PARTICLE | PARTICLE 1 | | |
| | Y5 | SMALL | 0.8 MASS % | |
| | | PARTICLE 2 | | |
| | | LARGE | 1.0 MASS % | |
| | | PARTICLE 1 | | |

TABLE 5

| | TONER | EXTERNAL ADDITIVE | | |
|---|---|---|---|---|
| TONER | PARTICLE | | ADDED | |
| NUMBER | NUMBER | KIND | AMOUNT | METHOD |
| TONER M1 | TONER | SMALL | 1.0 MASS % | METHOD 1 |
| | PARTICLE | PARTICLE 1 | | |
| | M1 | LARGE | 1.0 MASS % | |
| | | PARTICLE 1 | | |
| TONER M2 | TONER | SMALL | 1.0 MASS % | METHOD 2 |
| | PARTICLE | PARTICLE 1 | | |
| | M1 | LARGE | 1.0 MASS % | |
| | | PARTICLE 1 | | |
| TONER M3 | TONER | SMALL | 1.0 MASS % | METHOD 3 |
| | PARTICLE | PARTICLE 1 | | |
| | M1 | LARGE | 1.0 MASS % | |
| | | PARTICLE 1 | | |
| TONER M4 | TONER | SMALL | 1.0 MASS % | METHOD 4 |
| | PARTICLE | PARTICLE 1 | | |
| | M1 | LARGE | 1.0 MASS % | |
| | | PARTICLE 2 | | |
| TONER M5 | TONER | SMALL | 1.0 MASS % | METHOD 4 |
| | PARTICLE | PARTICLE 1 | | |
| | M1 | LARGE | 1.0 MASS % | |
| | | PARTICLE 3 | | |
| TONER M6 | TONER | SMALL | 1.0 MASS % | METHOD 1 |
| | PARTICLE | PARTICLE 1 | | |
| | M1 | SMALL | 0.8 MASS % | |
| | | PARTICLE 2 | | |
| | | LARGE | 1.0 MASS % | |
| | | PARTICLE 1 | | |
| TONER M7 | TONER | SMALL | 1.0 MASS % | METHOD 1 |
| | PARTICLE | PARTICLE 1 | | |
| | M1 | SMALL | 1.0 MASS % | |
| | | PARTICLE 1 | | |
| | | LARGE | 0.8 MASS % | |
| | | PARTICLE 4 | | |
| TONER M8 | TONER | SMALL | 1.0 MASS % | METHOD 1 |
| | PARTICLE | PARTICLE 1 | | |
| | M2 | SMALL | 0.8 MASS % | |
| | | PARTICLE 2 | | |
| | | LARGE | 1.0 MASS % | |
| | | PARTICLE 1 | | |
| TONER M9 | TONER | SMALL | 1.0 MASS % | METHOD 1 |
| | PARTICLE | PARTICLE 1 | | |
| | M3 | SMALL | 0.8 MASS % | |
| | | PARTICLE 2 | | |
| | | LARGE | 1.0 MASS % | |
| | | PARTICLE 1 | | |
| TONER | TONER | SMALL | 1.0 MASS % | METHOD 1 |
| M10 | PARTICLE | PARTICLE 1 | | |
| | M4 | SMALL | 0.8 MASS % | |
| | | PARTICLE 2 | | |
| | | LARGE | 1.0 MASS % | |
| | | PARTICLE 1 | | |
| TONER | TONER | SMALL | 1.0 MASS % | METHOD 1 |
| M11 | PARTICLE | PARTICLE 1 | | |
| | M5 | SMALL | 0.8 MASS % | |
| | | PARTICLE 2 | | |
| | | LARGE | 1.0 MASS % | |
| | | PARTICLE 1 | | |

TABLE 6

| | TONER | | | |
|---|---|---|---|---|
| | PARTICLE | EXTERNAL ADDITIVE | | |
| TONER NUMBER | NUMBER | KIND | ADDED AMOUNT | METHOD |
| TONER C1 | TONER | SMALL | 1.0 MASS % | METHOD 1 |
| | PARTICLE C1 | PARTICLE 1 | | |
| | | LARGE | 1.0 MASS % | |
| | | PARTICLE 1 | | |
| TONER C2 | TONER | SMALL | 1.0 MASS % | METHOD 2 |
| | PARTICLE C1 | PARTICLE 1 | | |
| | | LARGE | 1.0 MASS % | |
| | | PARTICLE 1 | | |
| TONER C3 | TONER | SMALL | 1.0 MASS % | METHOD 3 |
| | PARTICLE C1 | PARTICLE 1 | | |
| | | LARGE | 1.0 MASS % | |
| | | PARTICLE 1 | | |
| TONER C4 | TONER | SMALL | 1.0 MASS % | METHOD 4 |
| | PARTICLE C1 | PARTICLE 1 | | |
| | | LARGE | 1.0 MASS % | |
| | | PARTICLE 2 | | |
| TONER C5 | TONER | SMALL | 1.0 MASS % | METHOD 4 |
| | PARTICLE C1 | PARTICLE 1 | | |
| | | LARGE | 1.0 MASS % | |
| | | PARTICLE 3 | | |
| TONER C6 | TONER | SMALL | 1.0 MASS % | METHOD 1 |
| | PARTICLE C1 | PARTICLE 1 | | |
| | | SMALL | 0.8 MASS % | |
| | | PARTICLE 2 | | |
| | | LARGE | 1.0 MASS % | |
| | | PARTICLE 1 | | |
| TONER C7 | TONER | SMALL | 1.0 MASS % | METHOD 1 |
| | PARTICLE C1 | PARTICLE 1 | | |
| | | SMALL | 1.0 MASS % | |
| | | PARTICLE 1 | | |
| | | LARGE | 0.8 MASS % | |
| | | PARTICLE 4 | | |
| TONER C8 | TONER | SMALL | 1.0 MASS % | METHOD 1 |
| | PARTICLE C2 | PARTICLE 1 | | |
| | | SMALL | 0.8 MASS % | |
| | | PARTICLE 2 | | |
| | | LARGE | 1.0 MASS % | |
| | | PARTICLE 1 | | |
| TONER C9 | TONER | SMALL | 1.0 MASS % | METHOD 1 |
| | PARTICLE C3 | PARTICLE 1 | | |
| | | SMALL | 0.8 MASS % | |
| | | PARTICLE 2 | | |
| | | LARGE | 1.0 MASS % | |
| | | PARTICLE 1 | | |
| TONER C10 | TONER | SMALL | 1.0 MASS % | METHOD 1 |
| | PARTICLE C4 | PARTICLE 1 | | |
| | | SMALL | 0.8 MASS % | |
| | | PARTICLE 2 | | |
| | | LARGE | 1.0 MASS % | |
| | | PARTICLE 1 | | |
| TONER C11 | TONER | SMALL | 1.0 MASS % | METHOD 1 |
| | PARTICLE C5 | PARTICLE 1 | | |
| | | SMALL | 0.8 MASS % | |
| | | PARTICLE 2 | | |
| | | LARGE | 1.0 MASS % | |
| | | PARTICLE 1 | | |

[Adhesive Stress of Toner]

The adhesive stress F25 and the adhesive stress F50 were measured on each of the obtained toners, by the method described hereinafter. Further, an adhesive stress ratio (F25/F50) was calculated based on each pair of measured values of the adhesive stresses. The results are shown in Table 7 and Table 8.

(Measurement of Adhesive Stress)

The adhesive stresses F25 and F50 were measured using a measurement apparatus “Aggrobot” (available from Hosokawa Micron Corporation) for measuring the compressive and tensile characteristics of a powder layer. More specifically, according to measurement conditions for a spring wire having a diameter of 1.0 mm, in a measurement environment of 23° C. and 50% RH, a toner was filled in an amount of a volume of 10 cm³ in the compressed state in a hollow cylindrical cell that is dividable into an upper cell and a lower cell and has an inner diameter of 25 mm, and then, a toner layer formed by the toner filled in the cell was maintained under compression conditions of a compression speed 0.1 mm/sec and a compression stress of 2×10⁵ N/m², for a predetermined time period dependent on the temperature condition for setting the toner temperature to 25° C. or 50° C. (for 60 seconds in the case of the temperature condition setting the toner temperature to 25° C., or for 660 seconds in the case of the temperature condition setting the toner temperature to 50° C.). Then, the upper cell is lifted at a pulling speed of 0.4 mm/sec, and a maximum tensile stress (N/m²) acting when the toner is broken was measured as the adhesive stress F25 (for the toner temperature 25° C.) or the adhesive stress F50 (for the toner temperature 50° C.).

TABLE 7

| | |
|---|---|
| ADHESIVE | |
| STRESS | ADHESIVE STRESS |
| (N/m²) | RATIO |

| TONER NUMBER | F25 | F50 | F25/F50 |
|---|---|---|---|
| TONER K1 | 530 | 570 | 0.93 |
| TONER K2 | 540 | 590 | 0.92 |
| TONER K3 | 540 | 610 | 0.89 |
| TONER K4 | 560 | 650 | 0.86 |
| TONER K5 | 620 | 780 | 0.80 |
| TONER K6 | 520 | 550 | 0.95 |
| TONER K7 | 520 | 560 | 0.93 |
| TONER K8 | 530 | 580 | 0.91 |
| TONER K9 | 530 | 590 | 0.90 |
| TONER K10 | 540 | 620 | 0.87 |
| TONER K11 | 610 | 740 | 0.82 |
| TONER Y1 | 520 | 560 | 0.93 |
| TONER Y2 | 540 | 590 | 0.92 |
| TONER Y3 | 540 | 610 | 0.89 |
| TONER Y4 | 560 | 650 | 0.86 |
| TONER Y5 | 620 | 790 | 0.80 |
| TONER Y6 | 520 | 550 | 0.95 |
| TONER Y7 | 520 | 560 | 0.93 |
| TONER Y8 | 530 | 580 | 0.91 |
| TONER Y9 | 530 | 590 | 0.90 |
| TONER Y10 | 540 | 620 | 0.87 |
| TONER Y11 | 610 | 740 | 0.82 |

TABLE 8

| | |
|---|---|
| ADHESIVE | |
| STRESS | ADHESIVE STRESS |
| (N/m²) | RATIO |

| TONER NUMBER | F25 | F50 | F25/F50 |
|---|---|---|---|
| TONER M1 | 530 | 560 | 0.95 |
| TONER M2 | 540 | 590 | 0.92 |
| TONER M3 | 540 | 610 | 0.89 |
| TONER M4 | 560 | 650 | 0.86 |
| TONER M5 | 620 | 780 | 0.79 |
| TONER M6 | 520 | 550 | 0.95 |
| TONER M7 | 520 | 560 | 0.93 |
| TONER M8 | 530 | 580 | 0.91 |
| TONER M9 | 530 | 590 | 0.90 |
| TONER M10 | 540 | 620 | 0.87 |
| TONER M11 | 610 | 740 | 0.82 |
| TONER C1 | 530 | 570 | 0.93 |
| TONER C2 | 540 | 590 | 0.92 |
| TONER C3 | 540 | 610 | 0.89 |
| TONER C4 | 560 | 650 | 0.86 |
| TONER C5 | 630 | 780 | 0.81 |
| TONER C6 | 520 | 550 | 0.95 |
| TONER C7 | 520 | 560 | 0.93 |
| TONER C8 | 530 | 580 | 0.91 |
| TONER C9 | 530 | 590 | 0.90 |
| TONER C10 | 540 | 620 | 0.87 |
| TONER C11 | 610 | 740 | 0.82 |

### Preparation Example 1 of Toner Carrier

An aluminum roller with an external diameter of 14 mm was prepared as a conductive substrate, set in an elastic layer forming mold, and an elastic layer coating liquid, referred to hereinafter, was injected around the periphery of the roller in the mold, and cured by heating at 120° C. for 5 minutes. Further, a composite was obtained by heating the aluminum roller and the elastic layer coating liquid with the mold removed therefrom at 150° C. for one hour, and a surface of the composite was polished by a traverse-type cylindrical grinder, whereby an elastic layer having a thickness of 1 mm was formed on the periphery of the aluminum roller.

After the elastic layer formed on the outer periphery of the aluminum roller was subjected to a surface treatment using a silane coupling agent, an intermediate layer coating liquid, referred to hereinafter, was sprayed onto the surface of the elastic layer to form a coating, and the coating was dried, whereby an intermediate layer with a thickness of 10 μm was formed on the surface of the elastic layer.

Further, a surface layer coating liquid, referred to hereafter, was sprayed onto a surface of the intermediate layer formed on the surface of the elastic layer on the periphery of the aluminum roller to form a coating, and the coating was dried, whereby a surface layer with a thickness of 18 μm was formed on the surface of the intermediate layer. Thus, a toner carrier (hereinafter also referred to as “the toner carrier (1)”) was formed which has the elastic layer having a thickness of 1 mm, the intermediate layer having a thickness of 10 μm, and the surface layer having a thickness of 18 μm, laminated on the conductive substrate, in the mentioned order.

### Preparation of Elastic Layer Coating Liquid

50 parts by mass of liquid A and 50 parts by mass of liquid B of liquid silicone rubber “KE-1935” (available from Shin-Etsu Chemical Co., Ltd.), and 8 parts by mass of conductive carbon black “#3030” (available from Mitsubishi Chemical Co., Ltd.) were mixed and defoamed for 3 minutes by a stirring/defoaming apparatus “Hybrid Mixer H” (available from Keyence Corporation), whereby the elastic layer coating liquid was prepared.

[Preparation of Intermediate Layer Coating Liquid]

0.2 parts by mass of conductive carbon black “Ketjen black” (available from Lion Akzo Co., Ltd.) and 0.3 parts by mass of conductive carbon black “Printex XE2” (available from Degussa AG) were added to a solution prepared by dissolving 5 parts by mass of styrene butadiene elastomer “AR-S39948A” (available from Aron Kasei Co., Ltd ) in 100 parts by mass of toluene as a solvent, and the obtained liquid mixture was uniformly dispersed by the stirring/defoaming apparatus “Hybrid Mixer H” (available from Keyence Corporation), whereby the intermediate layer coating liquid was prepared.

[Preparation of Surface Layer Coating Liquid]

100 parts by mass of polyurethane resin emulsion “YODOSOLRX-7” (available from Japan NSC Co., Ltd.) having a solid content of 35 wt %, 0.35 parts by mass of conductive carbon black “Valcan XC-7” (available from Cabot Corporation), 3.5 parts by mass of roughness-imparting particles “Silica Sylophere 470” (available from Fuji Silysia Chemical LTD), and 8 mass % of polymethyl methacrylate particles “Epostar MA-1010” (available from Nippon Shokubai Co., Ltd.) having an average particle diameter of 10 μm are mixed and defoamed for 3 minutes by the stirring/defoaming apparatus “Hybrid Mixer H” (available from Keyence Corporation), whereby, a surface layer coating liquid was prepared.

The volume resistivities of the layers constituting the toner carrier (1) obtained, and the arithmetic mean roughness of the toner carrier were calculated by a method, referred to hereinafter, and the ten-point average roughness Rz of the toner carrier was also calculated. The results are shown in Table 9.

[Measurement of Volume Resistivities of Layers]

In measuring the volume resistivities of the elastic layer and the surface layer, a layer to be measured (elastic layer or surface layer) was formed according to the same method employed in preparing the toner carrier (1) on the surface of the aluminum roller in Preparation Example 1 of Toner Carrier, and 100 V of voltage was applied to the layer with a roller-shaped metal electrode pressed against the layer to be measured, whereby the volume resistivity of the layer was measured.

Further, in measuring the volume resistivity of the intermediate layer, a layer (intermediate layer) to be measured was formed according to the same method employed in producing the toner carrier (1) on the surface of the aluminum roller in Preparation Example 1 of Toner Carrier, and 100 V of voltage was applied to the layer with the roller-shaped metal electrode pressed against the layer, whereby the volume resistivity of the intermediate layer was measured.

[Measurement of Arithmetic Mean Roughness]

The arithmetic mean roughness of the toner carrier (1) was measured using a surface roughness measure “Surfcom 1400A” (available from Tokyo Seimitsu company limited), under measuring conditions of a scanning speed of 0.3 mm/sec, cutoff of 0.8 mm, measuring length of 4 mm, and measuring pressure of 0.7 mm/N.

### Preparation Example 2 of Toner Carrier

A toner carrier (hereinafter also referred to as “the toner carrier (2)”) was prepared in the same manner as in Preparation Example 1 of Toner Carrier except that in preparing a surface layer coating liquid, 3.5 parts by mass of roughness-imparting particles “Silica Sylophere 380” (available from Fuji Silysia Chemical LTD) was used in place of 3.5 parts by mass of roughness-imparting particles “Silica Sylophere 470” (available from Fuji Silysia Chemical LTD), and that the added amount of polymethyl methacrylate particles “Epostar MA-1010” (available from Nippon Shokubai Co., Ltd.) having an average particle diameter of 10 μm was changed to 12 mass %.

The respective volume resistivities of layers constituting the toner carrier (2) obtained, and the arithmetic mean roughness of the same were calculated in the same manner as in Preparation Example 1 of Toner Carrier. Further, the ten-point average roughness Rz of the toner carrier was calculated. The results are shown in Table 9.

### Preparation Example 3 of Toner Carrier

A toner carrier (hereinafter also referred to as “the toner carrier (3)”) was prepared in the same manner as in Preparation Example 1 of Toner Carrier except that in preparing a surface layer coating liquid, 5.0 parts by mass of roughness-imparting particles “Methyl silicone MSP-150” (available from Nikko Fine Products, Ltd) was used in place of 3.5 parts by mass of roughness-imparting particles “Silica Sylophere 470” (available from Fuji Silysia Chemical LTD), and that the added amount of polymethyl methacrylate particles “Epostar MA-1010” (available from Nippon Shokubai Co., Ltd.) having an average particle diameter of 10 μm was changed to 14 mass %.

The respective volume resistivities of layers constituting the toner carrier (3) obtained, and the arithmetic mean roughness of the same were calculated in the same manner as in Preparation Example 1 of Toner Carrier. Further, the ten-point average roughness Rz of the toner carrier was calculated. The results are shown in Table 9.

### Preparation Example 4 of Toner Carrier

A toner carrier (hereinafter also referred to as “the toner carrier (4)”) was prepared in the same manner as in Preparation Example 1 of Toner Carrier except that in preparing a surface layer coating liquid, 4.0 parts by mass of roughness-imparting particles “Silica Sylophere #440” (available from Fuji Silysia Chemical LTD) was used in place of 3.5 parts by mass of roughness-imparting particles “Silica Sylophere 470” (available from Fuji Silysia Chemical LTD), and that the added amount of polymethyl methacrylate particles “Epostar MA-1010” (available from Nippon Shokubai Co., Ltd.) having an average particle diameter of 10 μm was changed to 4 mass %.

The respective volume resistivities of layers constituting the toner carrier (4) obtained, and the arithmetic mean roughness of the same were calculated in the same manner as in Preparation Example 1 of Toner Carrier. Further, the ten-point average roughness Rz of the toner carrier was calculated. The results are shown in Table 9.

### Preparation Example 5 of Toner Carrier

A toner carrier (hereinafter also referred to as “the toner carrier (5”) was prepared in the same manner as in Preparation Example 1 of Toner Carrier except that in preparing a surface layer coating liquid, 6 parts by mass of roughness-imparting particles “Acrylic Particle EAX-20 (available from Sekisui Plastic Co., Ltd.) were used in place of 3.5 parts by mass of roughness-imparting particles “Silica Sylophere 470” (available from Fuji Silysia Chemical LTD), and that the added amount of polymethyl methacrylate particles “Epostar MA-1010” (available from Nippon Shokubai Co., Ltd.) having an average particle diameter of 10 μm was changed to 12 mass %.

The respective volume resistivities of layers constituting the toner carrier (5) obtained, and the arithmetic mean roughness of the same were calculated in the same manner as in Preparation Example 1 of Toner Carrier. Further, the ten-point average roughness Rz of the toner carrier was calculated. The results are shown in Table 9.

TABLE 9

| | | | | ARITHMETIC | |
|---|---|---|---|---|---|
| | | | | MEAN | |
| | VOLUME RESISTIVITY (Ω · m) | | | ROUGHNESS | |
| | σ1 | σ2 | σ3 | Ra (μm) | Rz |
| TONER | 4.8 × l0⁴ | 1.2 × l0³ | 2.7 × l0⁸ | 1.7 | 8.2 |
| CARRIER 1 | | | | | |
| TONER | 4.8 × l0⁴ | 1.2 × l0³ | 2.7 × l0⁸ | 1.0 | 12.3 |
| CARRIER 2 | | | | | |
| TONER | 4.8 × l0⁴ | 1.2 × l0³ | 2.7 × l0⁸ | 2.1 | 14.1 |
| CARRIER 3 | | | | | |
| TONER | 4.8 × l0⁴ | 1.2 × l0³ | 2.7 × l0⁸ | 0.7 | 4.2 |
| CARRIER 4 | | | | | |
| TONER | 4.8 × l0⁴ | 1.2 × l0³ | 2.7 × l0⁸ | 2.6 | 16.2 |
| CARRIER 5 | | | | | |

### Copying Tests 1 to 13

30,000 copies of a full color image print with a pixel ratio of 30% were continuously formed by using toners shown in Table 10 and Table 11 as non-magnetic single component developers, using an image forming apparatus constructed as shown in FIG. 2 and equipped with a developing device equipped with a toner carrier shown in Table 10 and Table 11, under normal temperature and normal humidity conditions of 20° C. and 50% RH. It was visually checked whether or not a 30,000-th image had image defects, such as untransferred part of characters, and at the same time the absolute image density was measured by a Macbeth reflection densitometer “RD-918”, at arbitrary 20 points of white portions of the 30,000-th image, with no fixed character images printed thereon to calculate an average value of the absolute value density. Then, a difference between this average value and an average value of values of the absolute image density measured at arbitrary 20 points of a transfer paper not yet subjected to image forming processing was calculated as a fogging density. The results of the calculations are shown in Table 10 and Table 11.

TABLE 10

| | | TONER | FOGGING | IMAGE |
|---|---|---|---|---|
| | DEVELOPER | CARRIER | DENSITY | DEFECT |
| COPYING | TONER K1 | TONER | 0.001 | NONE |
| TEST 1 | TONER Y1 | CARRIER 1 | | |
| | TONER M1 | | | |
| | TONER C1 | | | |
| COPYING | TONER K1 | TONER | 0.001 | NONE |
| TEST 2 | TONER Y1 | CARRIER 2 | | |
| | TONER M1 | | | |
| | TONER C1 | | | |
| COPYING | TONER K1 | TONER | 0.001 | NONE |
| TEST 3 | TONER Y1 | CARRIER 3 | | |
| | TONER M1 | | | |
| | TONER C1 | | | |
| COPYING | TONER K2 | TONER | 0.001 | NONE |
| TEST 4 | TONER Y2 | CARRIER 1 | | |
| | TONER M2 | | | |
| | TONER C2 | | | |
| COPYING | TONER K3 | TONER | 0.003 | NONE |
| TEST 5 | TONER Y3 | CARRIER 1 | | |
| | TONER M3 | | | |
| | TONER C3 | | | |
| COPYING | TONER K6 | TONER | 0.001 | NONE |
| TEST 6 | TONER Y6 | CARRIER 1 | | |
| | TONER M6 | | | |
| | TONER C6 | | | |
| COPYING | TONER K7 | TONER | 0.001 | NONE |
| TEST 7 | TONER Y7 | CARRIER 1 | | |
| | TONER M7 | | | |
| | TONER C7 | | | |
| COPYING | TONER K8 | TONER | 0.001 | NONE |
| TEST 8 | TONER Y8 | CARRIER 1 | | |
| | TONER M8 | | | |
| | TONER C8 | | | |
| COPYING | TONER K9 | TONER | 0.001 | NONE |
| TEST 9 | TONER Y9 | CARRIER 1 | | |
| | TONER M9 | | | |
| | TONER C9 | | | |

TABLE 11

| | | TONER | FOGGING | |
|---|---|---|---|---|
| | DEVELOPING AGENT | CARRIER | DENSITY | IMAGE DEFECT |
| COPYING | TONER K4 (COMPARATIVE) | TONER | 0.007 | SLIGHT |
| TEST 10 | TONER Y4 (COMPARATIVE) | CARRIER 4 | | UNTRANSFERRED |
| | TONER M4 (COMPARATIVE) | | | PART IN |
| | TONER C4 (COMPARATIVE) | | | CHARACTER |
| | | | | PORTION |
| COPYING | TONER K5 (COMPARATIVE) | TONER | 0.013 | BELT-LIKE |
| TEST 11 | TONER Y5 (COMPARATIVE) | CARRIER 5 | | UNEVEN TRANSFER |
| | TONER M5 (COMPARATIVE) | | | |
| | TONER C5 (COMPARATIVE) | | | |
| COPYING | TONER K10 (COMPARATIVE) | TONER | 0.006 | SLIGHT |
| TEST 12 | TONER Y10 (COMPARATIVE) | CARRIER 1 | | UNTRANSFERRED |
| | TONER M10 (COMPARATIVE) | | | PART IN |
| | TONER C10 (COMPARATIVE) | | | CHARACTER |
| | | | | PORTION |
| COPYING | TONER K11 (COMPARATIVE) | TONER | 0.011 | BELT-LIKE |
| TEST 13 | TONER Y11 (COMPARATIVE) | CARRIER 1 | | UNEVEN TRANSFER |
| | TONER M11 (COMPARATIVE) | | | |
| | TONER C11 (COMPARATIVE) | | | |

As results of the copying tests (1) to (9), it was confirmed that high-quality images can be stably obtained by the non-magnetic single component development system, since the developing agent used is the associated-type toner, and has a ratio related to specific magnitudes of adhesive stress, and the used toner carriers has a predetermined construction and satisfy predetermined conditions.

The toner according to the present invention is a so-called associated-type toner obtained by carrying out the step of salting-out/fusing resin particles and colorant particles in a water-base medium. The toner has a ratio related to specific magnitudes of adhesive stress, and therefore temperature dependency of the adhesiveness between toner particles is small, and therefore it is possible to obtain an excellent image formability. This makes it possible to give a necessary amount of electric charge to the toner without detrimental effects of the action of frictional charge by the toner carrier and the toner layer limiting member. This makes it possible to obtain a high-quality image over a long time period.

Therefore, according to the toner of the present invention, it is possible to stably obtain a high-quality image by the non-magnetic single component development system.

The image forming method of the present invention uses the toner described heretofore as the non-magnetic single component developer, and therefore it is possible to stably obtain high-quality images.

Further, in the image forming method according to the present invention, when a toner carrier has a predetermined construction and satisfies predetermined conditions, it is possible to obtain higher-quality images with higher stability.

The entire disclosure of Japanese Patent Application No. Tokugan 2002-273209 filed on Sep. 19, 2002 including specification, claims drawings and summary are incorporated herein by reference in its entirety.

What is claimed is:

1. A toner comprising a resin and a colorant;
wherein the toner is obtained by carrying out a step of salting-out/fusing resin particles and colorant particles in a water-base medium, the toner satisfying the following relationship:
0.88≦F25/F50≦1.0
where F25 represents an adhesive stress at a toner temperature of 25° C., and F50 represents an adhesive stress at a toner temperature of 50° C.

2. The toner of claim 1, wherein the toner has a volume average particle diameter of 9 μm or less.

3. The toner of claim 1, wherein the toner has a peak or a shoulder in a molecular weight distribution range from 100,000 to 1,000,000, and from 1,000 to 50,000.

4. The toner of claim 1, wherein the toner contains external additives having different number average primary particle diameters.

5. The toner of claim 4, wherein one of the external additives is a small-sized external additive having a number average primary particle diameter of 30 nm or less.

6. The toner of claim 5, wherein one of the external additives is a large-sized external additive having a number average primary particle diameter larger than that of the small-sized external additive, and of 15 to 70 nm.

7. An image forming method comprising the steps of:
limiting an amount of toner on a surface of a toner carrier by allowing a toner layer limiting member to be pressed to the surface of the toner carrier; and
developing an electrostatic latent image formed on an electrostatic latent image carrier using the toner carried and transferred by the toner carrier, based on a non-magnetic single component development system,
wherein the toner comprises a resin and a colorant, and is obtained by carrying out a step of salting-out/fusing resin particles and colorant particles in a water-base medium, the toner satisfying the following relationship:
0.88≦F25/F50≦1.0
where F25 represents an adhesive stress at a toner temperature of 25° C., and F50 represents an adhesive stress at a toner temperature of 50° C.

8. The image forming method of claim 7, wherein the toner has a volume average particle diameter of 9 μm or less.

9. The image forming method of claim 7, wherein the toner has a peak or a shoulder respectively in a molecular weight distribution range from 100,000 to 1,000,000, and from 1,000 to 50,000.

10. The image forming method of claim 7, wherein the toner contains external additives having different number average primary particle diameters.

11. The image forming method of claim 10, wherein one of the external additives is a small-sized external additive having a number average primary particle diameter of 30 nm or less.

12. The image forming method of claim 11, wherein one of the external additives is a large-sized external additive having a number average primary particle diameter larger than that of the small-sized external additive, and of 15 to 70 nm.

13. An image forming method comprising the steps of:
limiting an amount of toner on a surface of a toner carrier by allowing a toner layer limiting member to be pressed to the surface of the toner carrier; and
developing an electrostatic latent image formed on an electrostatic latent image carrier using the toner carried and transferred by the toner carrier, based on a non-magnetic single component development system,
wherein the toner comprises a resin and a colorant, and is obtained by carrying out a step of salting-out/fusing resin particles and colorant particles in a water-base medium, the toner satisfying the following relationship:
0.88≦F25/F50≦1.0
where F25 represents an adhesive stress at a toner temperature of 25° C., and F50 represents an adhesive stress at a toner temperature of 50° C., and
wherein the toner carrier has an arithmetic mean roughness Ra of 0.8 to 2.5 μm and a ten-point average roughness Rz of 5.0 to 15.0.

14. The image forming method of claim 13, wherein the toner has a peak or shoulder respectively in a molecular weight distribution range from 100,000 to 1,000,000, and from 1,000 to 50,000.

15. The image forming method of claim 13, wherein the toner contains external additives having different number average primary particle diameters.

16. The image forming method of claim 15, wherein one of the external additives is a small-sized external additive having a number average primary particle diameter of 30 nm or less.

17. The image forming method of claim 16, wherein one of the external additives is a large-sized external additive having a number average primary particle diameter larger than that of the small-sized external additive, and of 15 to 70 nm.
